(19) United States
(12) Patent Application Publication
(10) Pub. No.: US 2010/0080095 A1
(43) Pub. Date: Apr. 1, 2010

(54) RECORDING CONTROL METHOD, RECORDING/REPRODUCTION METHOD, RECORDING CONTROL APPARATUS AND RECORDING/REPRODUCTION APPARATUS

(75) Inventors: Isao KOBAYASHI, Kadoma-shi (JP); Atsushi NAKAMURA, Kadoma-shi (JP); Yasumori HINO, Kadoma-shi (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/243,086

(22) Filed: Oct. 1, 2008

(51) Int. Cl. G11B 20/00

(52) U.S. Cl. 369/47.15; G9B/20

(57) ABSTRACT

Information is recorded on an information recording medium by classifying recording conditions by data pattern, including at least one recording mark and at least one space, of a data stream to be recorded; wherein the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space. Alternatively, the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

### BACKGROUND OF THE INVENTION

1. Field of the Invention

The present invention relates to a recording control apparatus, a recording and reproduction apparatus, a recording control method, and a recording and reproduction method for realizing high density recording more stably on an information recording medium having an information recording surface on which information is optically recordable.

2. Description of the Related Art

Today, various types of recordable information recording mediums are available for storing video or audio data or personal computer data. For example, optical discs such as CDs and DVDs are available as information recording mediums, and recently BDs (Blu-ray Discs) are on the market by which high definition video of high image quality including video of digital broadcasting can be enjoyed.

For realizing higher density recording on the above-described optical discs, recording marks used for recording information need to be smaller. As the recording marks are made smaller, the length of the shortest recording marks approaches the limit of the optical resolving power. As a result, increase of inter-code interference and deterioration of SNR (Signal to Noise Ratio) become more conspicuous. Therefore, a PRML (Partial Response Maximum Likelihood) system or the like is now used generally as a reproduction signal processing method. The PRML system is a technology generated by combining partial response (PR) and maximum likelihood (ML). By the PRML system, with a premise that known inter-code interference occurs, a signal stream having the maximum likelihood is selected from a reproduction waveform.

In order to perform high density recording, the length of the space between the recording marks needs to be reduced. As the length of the space is reduced, thermal interference occurs so that the heat at the end of a recording mark is conveyed through the space and influences the temperature rise at the start of the next recording mark, or the heat at the start of the next recording mark influences the cooling process at the end of the immediately previous recording mark. By the influence of the thermal interference, the edge position of the recording mark is changed, which makes it necessary to fine-tune the pulse shape of the recording laser light in accordance with the length of the space (hereinafter, this fine-tuning will be referred to as the “space compensation”).

The pulse waveform of the recording laser light will be briefly described. FIG. 2 illustrates recording pulse waveforms and the recording powers.

FIG. 2(a) shows the cycle Tw of a channel clock, which is the reference signal for creating recording data. By the cycle Tw, the time interval between a recording mark and a space of an NRZI (Non Return to Zero Inverting) signal is determined. The NRZI signal is a recording signal shown in FIG. 2(b). FIG. 2(b) shows a 2T mark-2T space-4T mark recording pattern as a partial example of the NRZI signal.

FIG. 2(c) shows a multi-pulse stream of laser light for creating recording marks. A recording power Pw of the multi-pulse stream includes a peak power Pp201 providing a heating effect required to form recording marks, a bottom power Pb202 and a cooling power Pc203 providing a cooling effect, and a space power Ps204, which is the recording power in the space. The peak power Pp201, the bottom power Pb202, the cooling power Pc203 and the space power Ps204 are set with respect to the reference level, which is an extinction level 205 detected when the laser light is off.

The bottom power Pb202 and the cooling power Pc203 are set to an equivalent recording power. However, the cooling power Pc203 may occasionally be set to a different power from the bottom power Pb202 in order to adjust the heat amount at the end of a recording mark. For the space, the space power Ps204 is generally set to a low recording power (for example, a recording power equivalent to a reproduction power or the bottom power) because it is not necessary to form a recording mark. However, the space power Ps204 may occasionally be set to a relatively high recording power for a rewritable optical disc (for example, DVD-RAM or BD-RE) because the existing recording mark needs to be erased to create a space. Also for a write once optical disc (for example, DVD-R or BD-R), the space power Ps204 may occasionally be set to a relatively high recording power as a preheating power for creating the next recording mark. Even in such cases, the space power Ps204 is not set to a recording power higher than the peak power Pp201.

Regarding the pulse width, a leading pulse width Ttop is set for each of 2T, 3T, 4T and longer recording signals. Pulse widths Tmp after Ttop in 3T or longer multi-pulse streams are set to the same, and the last pulse width Tmp is set as a last pulse width Tlp. In each recording mark length, a recording start position offset dTtop for adjusting the start position of the recording mark and a recording end position offset dTs for adjusting the end position of the recording mark are set. “Space compensation” means changing a recording parameter (for example, dTtop) of the recording pulse in accordance with the length of the space immediately previous or subsequent to the recording mark.

Laser light emitting conditions at the time of recording, including the value of each recording power and the pulse width of the multi-pulse stream, are described in an optical disc. Accordingly, the recording marks shown in FIG. 2(d) can be created by reproducing the recording powers and the pulse width of the multi-pulse stream described in the optical disc and irradiating the recording layer of the optical disc with the laser light.

As the recording pulse waveform, waveforms as shown in FIG. 3 are available in addition to the multi-pulse waveform shown in FIG. 2(c). FIG. 3(a) shows a mono-pulse waveform, FIG. 3(b) shows an L-shaped pulse waveform, and FIG. 3(c) shows a Castle-type pulse waveform. Different recording pulse waveforms are different in the heat amount accumulated in the recording layer of an optical disc, and a recording pulse waveform suitable to the film characteristic of the recording layer is selected in order to create an optimal recording mark.

The above-described conventional art of a recording control method in consideration of the influence of the inter-code interference and the thermal interference is described in, for example, Japanese Laid-Open Patent Publications Nos. 2004-335079 and 2008-112509.

According to Japanese Laid-Open Patent Publication No. 2004-335079, a bit stream as a demodulation result (correct bit stream) and a bit stream with a maximum likelihood of error, generated as a result of one bit of the correct bit stream being shifted (incorrect big stream) are used to calculate an Euclidian distance between the reproduction signal and each of both bit streams. Thus, a reproduction signal adaptively equalized is evaluated, thereby detecting an edge shift direction and an edge shift amount of each pattern. The adaptive recording parameters organized in a table by the length of the spaces and marks immediately previous and subsequent to the target recording mark are optimized in accordance with the edge shift direction and the edge shift amount corresponding to each pattern.

According to Japanese Laid-Open Patent Publication No. 2008-112509, for an edge at which one bit is shifted from a correct bit stream and an incorrect bit stream, a difference between the amplitude value of an adaptively equalized reproduction signal and an expected amplitude value calculated in both streams is quantified. Thus, an edge shift direction and an edge shift amount are detected. Like in Japanese Laid-Open Patent Publication No. 2008-335079, the adaptive recording parameters organized in a table by the length of the spaces and marks immediately previous and subsequent to the target recording mark are optimized in accordance with the edge shift direction and the edge shift amount corresponding to each pattern.

As a description of a conventional recording control apparatus, recording pulse control described in Japanese Laid-Open Patent Publication No. 2008-335079 will be described briefly with reference to FIG. 4.

Information read from an information recording medium 1 is generated as an analog reproduction signal by an optical head 2. The analog reproduction signal is amplified and AC-coupled by a preamplifier 3, and then input to an AGC section 4. The AGC section 4 adjusts the amplitude such that the output from a waveform equalizer 5 on a later stage has a constant amplitude. The amplitude-adjusted analog reproduction signal is waveform-shaped by the waveform equalizer 5 and input to an A/D conversion section 6. The A/D conversion section 6 samples the analog reproduction signal in synchronization with a reproduction clock output from a PLL section 7. The PLL section 7 extracts the reproduction clock from a digital reproduction signal obtained by the sampling performed by the A/D conversion section 6.

The digital reproduction signal generated by the sampling performed by the A/D conversion section 6 is input to a PR equalization section 8. The PR equalization section 8 adjusts the frequency of the digital reproduction signal such that the frequency characteristic of the digital reproduction signal at the time of recording and reproduction is the characteristic assumed by a maximum likelihood decoding section 9 (for example, PR(1,2,2,1) equalization characteristic). The maximum likelihood decoding section 9 performs maximum likelihood decoding on the waveform-shaped digital reproduction signal output from the PR equalization section 8 to generate a binary signal. The reproduction signal processing technology provided by combining the PR equalization section 8 and the maximum likelihood decoding section 9 is the PRML system.

An edge shift detection section 10 receives the waveform-shaped digital reproduction signal output from the PR equalization section 8 and the binary signal output from the maximum likelihood decoding section 9. The edge shift detection section 10 distinguishes a state transfer from the binary signal, and finds the reliability of the decoding result from the distinguishing result and the branch metric. The edge shift detection section 10 also assigns the reliability for each of leading edge/trailing edge patterns of recording marks based on the binary signal and finds a shift of a recording compensation parameter from the optimal value (hereinafter, the shift will be referred to as the “edge shift”).

An information recording control section 15 changes a recording parameter, the setting change of which is predetermined as being possible, in conformity to the information indicating that the setting change of the recording parameter is determined as being required based on the edge shift amount detected for each pattern. The recording parameters, the setting of which is changeable, are predetermined. Such recording parameters include, for example, the recording start position offset dTtop regarding the leading edge of a recording mark and the recording end position offset dTs regarding the trailing edge of a recording mark. The information recording control section 15 changes the recording parameter in accordance with the table of the recording parameters shown in FIG. 5. FIG. 5 shows an example of space compensation of the recording parameters. FIG. 5(a) shows the relationship between the recording mark length and the space immediately previous thereto regarding the leading edge, and FIG. 5(b) shows the relationship between the recording mark length and the space immediately subsequent thereto regarding the trailing edge.

In FIG. 5, the symbols of recording mark M′(i), immediately previous space S(i−1) and immediately subsequent space S(i+1) are used in the time series of recording marks and spaces shown in FIG. 6. Symbol M represents a recording mark and symbol S represents a space. A position in the time series of an arbitrary recording mark or space is represented using symbol i. The recording mark corresponding to the recording parameter shown in FIG. 5 is represented by M(i). Accordingly, a space immediately previous to the recording mark M(i) is S(i−1), a recording mark further immediately previous is M(i−2), and a space still further immediately previous is S(i−3). A space immediately subsequent to the recording mark M(i) is S(i+1), a recording mark further immediately subsequent is M(i+2), and a space still further immediately subsequent is S(i+3). For example, referring to FIG. 5, pattern 3Ts4Tm shown regarding the leading edge has the relationships of S(i−1)=3T and M(i)=4T. Pattern 3Tm2Ts shown regarding the trailing edge has the relationships of M(i)=3T and S(i+1)=2T. In FIG. 5, a total of 32 recording parameters are shown regarding the leading edge and the trailing edge.

In order to adjust, for example, the leading edge of a recording mark of 4T having an immediately previous space of 3T, the information recording control section 15 changes a recording parameter of 3Ts4Tm (for example, dTop). In order to adjust, for example, the trailing edge of a recording mark of 3T having an immediately subsequent space of 2T, the information recording control section 15 changes a recording parameter of 3Tm2Ts (for example, dTs).

A recording pattern generation section 11 generates an NRZI signal which indicates a recording pattern, from the input recording data. A recording compensation section 12 generates a recording pulse stream in accordance with the NRZI signal based on the recording parameter changed by the information recording control section 15. A recording power setting section 14 sets recording powers including the peak power Pp, the bottom power Pb and the like. A laser driving section 13 controls the laser light emitting operation of the optical head 2 in accordance with the recording pulse stream and the recording powers set by the recording power setting section 14.

In this manner, recording to or reproduction from the information recording medium 1 is performed, and a recording pulse shape is controlled so as to decrease the edge shift amount.

By the above-described recording control method using the PRML system and space compensation of recording parameters, more appropriate recording marks and spaces can be formed.

As the recording density of information recording mediums is more improved, the problems of the inter-code interference and SNR deterioration become more serious. “Illustrated Blu-ray Disc Reader” published by Ohmsha, Ltd. describes that the system margin of an information recording and reproduction apparatus can be maintained by using a higher-order PRML system. For example, when the recording capacity of one recording layer of a 12-cm optical disc medium is 25 GB, the system margin can be maintained by adopting the PR1221ML system. It is described, however, that when the recording capacity of one recording layer is 33.3 GB, the PR12221ML system needs to be adopted. In this manner, the tendency of adopting a higher-order PRML system is expected to continue as the density of the information recording medium is more and more improved.

As an example of using a high-order PRML system, an edge shift in the PR12221ML system will be described.

As the recording density of the information recording medium is improved, marks and spaces which are shorter than the resolving power of the detection system appear. For determining the recording quality of the information recording medium, a positional shift of a mark itself and a positional shift of a space itself, namely, a positional shift of a set of at least one mark and at least one space needs to be considered in addition to a positional shift between a mark and a space. For such positional shifts, a pattern including a plurality of edges is detected. For example, in the case of a positional shift of a mark itself, there is a space at the start and the end of the mark, and so the leading edge and the trailing edge are detected at the same time. In the case of a positional shift of a set of one mark and one space, for example, “mark A-space B”, another space and another mark are present adjacent to the mark and the space, as “space A-mark A-space B-mark B”. Therefore, a total of three edges are detected. With the conventional PR1221ML system, it is considered to evaluate the recording quality when one edge is detected. With the PR12221ML system, the recording quality when a pattern including a plurality of edge shifts is detected as described above needs to be evaluated.

With reference to FIG. 7, a signal evaluation apparatus using a PR12221ML system for signal processing of a reproduction system will be described. In the signal evaluation apparatus shown in FIG. 7, identical elements with those in FIG. 4 bear identical reference numerals therewith, and identical descriptions thereof will be omitted. The recording code is the RLL (Run Length Limited) code such as the RLL(1,7) code.

First, with reference to FIG. 8 and FIG. 9, PR12221ML will be briefly described. FIG. 8 is a state transition diagram showing a state transition rule defined by the RLL(1,7) recording code and the equalization system PR(1,2,2,2,1). FIG. 9 is a trellis diagram corresponding to the state transition rule shown in FIG. 8.

By the combination of PR12221ML and RLL(1,7), the number of states in a decoding section is limited to 10, the number of state transition paths is 16, and the number of reproduction levels are 9.

Referring to the state transition rule of PR12221 shown in FIG. 8, ten states at a certain time are represented as follows. State S(0,0,0,0) is represented as “0, state S(0,0,0,1) is represented as S1, state S(0,0,1,1) is represented as S2,state S(0,1,1,1) is represented as S3, state S(1,1,1,1) is represented as S4, state S(1,1,1,0) is represented as S5, state S(1,1,0,0) is represented as S6, state S(1,0,0,0) is represented as S7, state S(1,0,0,1) is represented as S8, and state S(0,1,1,0) is represented as S9. “0” or “1” in parentheses represents a signal on the time axis, and represents which state will possibly occur at the next time by a state transition from one state. The trellis diagram shown in FIG. 9 is obtained by developing this state transition diagram along the time axis.

In the state transition of PR12221ML shown in FIG. 9, there are numerous state transition matrix patterns (state combinations) by which a prescribed state at one time is changed to another prescribed state at the next time via either one of two state transitions. However, the patterns which are highly likely to cause an error are limited to specific patterns which are difficult to be distinguished. Focusing on such patterns which are likely to cause an error, the state transition matrix patterns of PR12221 can be summarized as Tables 1, 2 and 3.

TABLE 1

| | | | | | | | | | | | | | PR | | | | | Inter-Path |
|---|---|---|---|---|---|---|---|---|---|---|---|---|---|---|---|---|---|---|
| | Transition Data Stream | | k − | k − | k − | k − | k − | k − | k − | k − | k − | | Equalization | | | | | Euclidean |
| State Transition | (bₖ₋ᵢ, . . . , bₖ) | Pattern | 9 | 8 | 7 | 6 | 5 | 4 | 3 | 2 | 1 | k | Ideal Value | | | | | Distance |
| S0ₖ₋₅ → S6ₖ | (0, 0, 0, 0, x, 1, 1, 0, 0) | [14]1A | | | | | S0 | S1 | S2 | S3 | S5 | S6 | 1 | 3 | 5 | 6 | 5 | |
| | | [14]1B | | | | | S0 | S0 | S1 | S2 | S9 | S6 | 0 | 1 | 3 | 4 | 4 | 14 |
| S0ₖ₋₅ → S5ₖ | (0, 0, 0, 0, x, 1, 1, 1, 0) | [14]2A | | | | | S0 | S1 | S2 | S3 | S4 | S5 | 1 | 3 | 5 | 7 | 7 | |
| | | [14]2B | | | | | S0 | S0 | S1 | S2 | S3 | S5 | 0 | 1 | 3 | 5 | 6 | 14 |
| S0ₖ₋₅ → S4ₖ | (0, 0, 0, 0, x, 1, 1, 1, 1) | [14]3A | | | | | S0 | S1 | S2 | S3 | S4 | S4 | 1 | 3 | 5 | 7 | 8 | |
| | | [14]3B | | | | | S0 | S0 | S1 | S2 | S3 | S4 | 0 | 1 | 3 | 5 | 7 | 14 |
| S2ₖ₋₅ → S0ₖ | (0, 0, 1, 1, x, 0, 0, 0, 0) | [14]4A | | | | | S2 | S3 | S5 | S6 | S7 | S0 | 5 | 6 | 5 | 3 | 1 | |
| | | [14]4B | | | | | S2 | S9 | S6 | S7 | S0 | S0 | 4 | 4 | 3 | 1 | 0 | 14 |
| S2ₖ₋₅ → S1ₖ | (0, 0, 1, 1, x, 0, 0, 0, 1) | [14]5A | | | | | S2 | S3 | S5 | S6 | S7 | S1 | 5 | 6 | 5 | 3 | 2 | |
| | | [14]5B | | | | | S2 | S9 | S6 | S7 | S0 | S1 | 4 | 4 | 3 | 1 | 1 | 14 |
| S2ₖ₋₅ → S2ₖ | (0, 0, 1, 1, x, 0, 0, 1, 1) | [14]6A | | | | | S2 | S3 | S5 | S6 | S8 | S2 | 5 | 6 | 5 | 4 | 4 | |
| | | [14]6B | | | | | S2 | S9 | S6 | S7 | S1 | S2 | 4 | 4 | 3 | 2 | 3 | 14 |
| S3ₖ₋₅ → S0ₖ | (0, 1, 1, 1, x, 0, 0, 0, 0) | [14]7A | | | | | S3 | S4 | S5 | S6 | S7 | S0 | 7 | 7 | 5 | 3 | 1 | |
| | | [14]7B | | | | | S3 | S5 | S6 | S7 | S0 | S0 | 6 | 5 | 3 | 1 | 0 | 14 |
| S3ₖ₋₅ → S1ₖ | (0, 1, 1, 1, x, 0, 0, 0, 1) | [14]8A | | | | | S3 | S4 | S5 | S6 | S7 | S1 | 7 | 7 | 5 | 3 | 2 | |
| | | [14]8B | | | | | S3 | S5 | S6 | S7 | S0 | S1 | 6 | 5 | 3 | 1 | 1 | 14 |
| S3ₖ₋₅ → S2ₖ | (0, 1, 1, 1, x, 0, 0, 1, 1) | [14]9A | | | | | S3 | S4 | S5 | S6 | S8 | S2 | 7 | 7 | 5 | 4 | 4 | |
| | | [14]9B | | | | | S3 | S5 | S6 | S7 | S1 | S2 | 6 | 5 | 3 | 2 | 3 | 14 |
| S7ₖ₋₅ → S6ₖ | (1, 0, 0, 0, x, 1, 1, 0, 0) | [14]10A | | | | | S7 | S1 | S2 | S3 | S5 | S6 | 2 | 3 | 5 | 6 | 5 | |
| | | [14]10B | | | | | S7 | S0 | S1 | S2 | S9 | S6 | 1 | 1 | 3 | 4 | 4 | 14 |
| S7ₖ₋₅ → S5ₖ | (1, 0, 0, 0, x, 1, 1, 1, 0) | [14]11A | | | | | S7 | S1 | S2 | S3 | S4 | S5 | 2 | 3 | 5 | 7 | 7 | |
| | | [14]11B | | | | | S7 | S0 | S1 | S2 | S3 | S5 | 1 | 1 | 3 | 5 | 6 | 14 |
| S7ₖ₋₅ → S4ₖ | (1, 0, 0, 0, x, 1, 1, 1, 1) | [14]12A | | | | | S7 | S1 | S2 | S3 | S4 | S4 | 2 | 3 | 5 | 7 | 8 | |
| | | [14]12B | | | | | S7 | S0 | S1 | S2 | S3 | S4 | 1 | 1 | 3 | 5 | 7 | 14 |
| S6ₖ₋₅ → S6ₖ | (1, 1, 0, 0, x, 1, 1, 0, 0) | [14]13A | | | | | S6 | S8 | S2 | S3 | S5 | S6 | 4 | 4 | 5 | 6 | 5 | |
| | | [14]13B | | | | | S6 | S7 | S1 | S2 | S9 | S6 | 3 | 2 | 3 | 4 | 4 | 14 |
| S6ₖ₋₅ → S5ₖ | (1, 1, 0, 0, x, 1, 1, 1, 0) | [14]14A | | | | | S6 | S8 | S2 | S3 | S4 | S5 | 4 | 4 | 5 | 7 | 7 | |
| | | [14]14B | | | | | S6 | S7 | S1 | S2 | S3 | S5 | 3 | 2 | 3 | 5 | 6 | 14 |
| S6ₖ₋₅ → S4ₖ | (1, 1, 0, 0, x, 1, 1, 1, 1) | [14]15A | | | | | S6 | S8 | S2 | S3 | S4 | S4 | 4 | 4 | 5 | 7 | 8 | |
| | | [14]15B | | | | | S6 | S7 | S1 | S2 | S3 | S4 | 3 | 2 | 3 | 5 | 7 | 14 |
| S4ₖ₋₅ → S0ₖ | (1, 1, 1, 1, x, 0, 0, 0, 0) | [14]16A | | | | | S4 | S4 | S5 | S6 | S7 | S0 | 8 | 7 | 5 | 3 | 1 | |
| | | [14]16B | | | | | S4 | S5 | S6 | S7 | S0 | S0 | 7 | 5 | 3 | 1 | 0 | 14 |
| S4ₖ₋₅ → S1ₖ | (1, 1, 1, 1, x, 0, 0, 0, 1) | [14]17A | | | | | S4 | S4 | S5 | S6 | S7 | S1 | 8 | 7 | 5 | 3 | 2 | |
| | | [14]17B | | | | | S4 | S5 | S6 | S7 | S0 | S1 | 7 | 5 | 3 | 1 | 1 | 14 |
| S4ₖ₋₅ → S2ₖ | (1, 1, 1, 1, x, 0, 0, 1, 1) | [14]18A | | | | | S4 | S4 | S5 | S6 | S8 | S2 | 8 | 7 | 5 | 4 | 4 | |
| | | [14]18B | | | | | S4 | S5 | S6 | S7 | S1 | S2 | 7 | 5 | 3 | 2 | 3 | 14 |

TABLE 2

| | | | | | | | | | | | | | | | | | | | | Inter-Path |
|---|---|---|---|---|---|---|---|---|---|---|---|---|---|---|---|---|---|---|---|---|
| State | Transition Data Stream | | k − | k − | k − | k − | k − | k − | k − | k − | k − | | | | | | | | | Euclidean |
| Transition | (bₖ₋ᵢ, . . . , bₖ) | Pattern | 9 | 8 | 7 | 6 | 5 | 4 | 3 | 2 | 1 | k | PR Equalization Ideal Value | | | | | | | Distance |
| S0ₖ₋₇ → S0ₖ | (0, 0, 0, 0, x, 1, !x, 0, 0, 0, 0) | [12A]1A | | | S0 | S1 | S2 | S9 | S6 | S7 | S0 | S0 | 1 | 3 | 4 | 4 | 3 | 1 | 0 | |
| | | [12A]1B | | | S0 | S0 | S1 | S2 | S9 | S6 | S7 | S0 | 0 | 1 | 3 | 4 | 4 | 3 | 1 | 12 |
| S0ₖ₋₇ → S1ₖ | (0, 0, 0, 0, x, 1, !x, 0, 0, 0, 1) | [12A]2A | | | S0 | S1 | S2 | S9 | S6 | S7 | S0 | S1 | 1 | 3 | 4 | 4 | 3 | 1 | 1 | |
| | | [12A]2B | | | S0 | S0 | S1 | S2 | S9 | S6 | S7 | S1 | 0 | 1 | 3 | 4 | 4 | 3 | 2 | 12 |
| S0ₖ₋₇ → S2ₖ | (0, 0, 0, 0, x, 1, !x, 0, 0, 1, 1) | [12A]3A | | | S0 | S1 | S2 | S9 | S6 | S7 | S1 | S2 | 1 | 3 | 4 | 4 | 3 | 2 | 3 | |
| | | [12A]3B | | | S0 | S0 | S1 | S2 | S9 | S6 | S8 | S2 | 0 | 1 | 3 | 4 | 4 | 4 | 4 | 12 |
| S2ₖ₋₇ → S6ₖ | (0, 0, 1, 1, x, 0, !x, 1, 1, 0, 0) | [12A]4A | | | S2 | S3 | S5 | S6 | S8 | S2 | S9 | S6 | 5 | 6 | 5 | 4 | 4 | 4 | 4 | |
| | | [12A]4B | | | S2 | S9 | S6 | S8 | S2 | S3 | S5 | S6 | 4 | 4 | 4 | 4 | 5 | 6 | 5 | 12 |
| S2ₖ₋₇ → S5ₖ | (0, 0, 1, 1, x, 0, !x, 1, 1, 1, 0) | [12A]5A | | | S2 | S3 | S5 | S6 | S8 | S2 | S3 | S5 | 5 | 6 | 5 | 4 | 4 | 5 | 6 | |
| | | [12A]5B | | | S2 | S9 | S6 | S8 | S2 | S3 | S4 | S5 | 4 | 4 | 4 | 4 | 5 | 7 | 7 | 12 |
| S2ₖ₋₇ → S4ₖ | (0, 0, 1, 1, x, 0, !x, 1, 1, 1, 1) | [12A]6A | | | S2 | S3 | S5 | S6 | S8 | S2 | S3 | S4 | 5 | 6 | 5 | 4 | 4 | 5 | 7 | |
| | | [12A]6B | | | S2 | S9 | S6 | S8 | S2 | S3 | S4 | S4 | 4 | 4 | 4 | 4 | 5 | 7 | 8 | 12 |
| S3ₖ₋₇ → S6ₖ | (0, 1, 1, 1, x, 0, !x, 1, 1, 0, 0) | [12A]7A | | | S3 | S4 | S5 | S6 | S8 | S2 | S9 | S6 | 7 | 7 | 5 | 4 | 4 | 4 | 4 | |
| | | [12A]7B | | | S3 | S5 | S6 | S8 | S2 | S3 | S5 | S6 | 6 | 5 | 4 | 4 | 5 | 6 | 5 | 12 |
| S3ₖ₋₇ → S5ₖ | (0, 1, 1, 1, x, 0, !x, 1, 1, 1, 0) | [12A]8A | | | S3 | S4 | S5 | S6 | S8 | S2 | S3 | S5 | 7 | 7 | 5 | 4 | 4 | 5 | 6 | |
| | | [12A]8B | | | S3 | S5 | S6 | S8 | S2 | S3 | S4 | S5 | 6 | 5 | 4 | 4 | 5 | 7 | 7 | 12 |
| S3ₖ₋₇ → S4ₖ | (0, 1, 1, 1, x, 0, !x, 1, 1, 1, 1) | [12A]9A | | | S3 | S4 | S5 | S6 | S8 | S2 | S3 | S4 | 7 | 7 | 5 | 4 | 4 | 5 | 7 | |
| | | [12A]9B | | | S3 | S5 | S6 | S8 | S2 | S3 | S4 | S4 | 6 | 5 | 4 | 4 | 5 | 7 | 8 | 12 |
| S7ₖ₋₇ → S0ₖ | (1, 0, 0, 0, x, 1, !x, 0, 0, 0, 0) | [12A]10A | | | S7 | S1 | S2 | S9 | S6 | S7 | S0 | S0 | 2 | 3 | 4 | 4 | 3 | 1 | 0 | |
| | | [12A]10B | | | S7 | S0 | S1 | S2 | S9 | S6 | S7 | S0 | 1 | 1 | 3 | 4 | 4 | 3 | 1 | 12 |
| S7ₖ₋₇ → S1ₖ | (1, 0, 0, 0, x, 1, !x, 0, 0, 0, 1) | [12A]11A | | | S7 | S1 | S2 | S9 | S6 | S7 | S0 | S1 | 2 | 3 | 4 | 4 | 3 | 1 | 1 | |
| | | [12A]11B | | | S7 | S0 | S1 | S2 | S9 | S6 | S7 | S1 | 1 | 1 | 3 | 4 | 4 | 3 | 2 | 12 |
| S7ₖ₋₇ → S2ₖ | (1, 0, 0, 0, x, 1, !x, 0, 0, 1, 1) | [12A]12A | | | S7 | S1 | S2 | S9 | S6 | S7 | S1 | S2 | 2 | 3 | 4 | 4 | 3 | 2 | 3 | |
| | | [12A]12B | | | S7 | S0 | S1 | S2 | S9 | S6 | S8 | S2 | 1 | 1 | 3 | 4 | 4 | 4 | 4 | 12 |
| S6ₖ₋₇ → S0ₖ | (1, 1, 0, 0, x, 1, !x, 0, 0, 0, 0) | [12A]13A | | | S6 | S8 | S2 | S9 | S6 | S7 | S0 | S0 | 4 | 4 | 4 | 4 | 3 | 1 | 0 | |
| | | [12A]13B | | | S6 | S7 | S1 | S2 | S9 | S6 | S7 | S0 | 3 | 2 | 3 | 4 | 4 | 3 | 1 | 12 |
| S6ₖ₋₇ → S1ₖ | (1, 1, 0, 0, x, 1, !x, 0, 0, 0, 1) | [12A]14A | | | S6 | S8 | S2 | S9 | S6 | S7 | S0 | S1 | 4 | 4 | 4 | 4 | 3 | 1 | 1 | |
| | | [12A]14B | | | S6 | S7 | S1 | S2 | S9 | S6 | S7 | S1 | 3 | 2 | 3 | 4 | 4 | 3 | 2 | 12 |
| S6ₖ₋₇ → S2ₖ | (1, 1, 0, 0, x, 1, !x, 0, 0, 1, 1) | [12A]15A | | | S6 | S8 | S2 | S9 | S6 | S7 | S1 | S2 | 4 | 4 | 4 | 4 | 3 | 2 | 3 | |
| | | [12A]15B | | | S6 | S7 | S1 | S2 | S9 | S6 | S8 | S2 | 3 | 2 | 3 | 4 | 4 | 4 | 4 | 12 |
| S4ₖ₋₇ → S6ₖ | (1, 1, 1, 1, x, 0, !x, 1, 1, 0, 0) | [12A]16A | | | S4 | S4 | S5 | S6 | S8 | S2 | S9 | S6 | 8 | 7 | 5 | 4 | 4 | 4 | 4 | |
| | | [12A]16B | | | S4 | S5 | S6 | S8 | S2 | S3 | S5 | S6 | 7 | 5 | 4 | 4 | 5 | 6 | 5 | 12 |
| S4ₖ₋₇ → S5ₖ | (1, 1, 1, 1, x, 0, !x, 1, 1, 1, 0) | [12A]17A | | | S4 | S4 | S5 | S6 | S8 | S2 | S3 | S5 | 8 | 7 | 5 | 4 | 4 | 5 | 6 | |
| | | [12A]17B | | | S4 | S5 | S6 | S8 | S2 | S3 | S4 | S5 | 7 | 5 | 4 | 4 | 5 | 7 | 7 | 12 |
| S4ₖ₋₇ → S4ₖ | (1, 1, 1, 1, x, 0, !x, 1, 1, 1, 1) | [12A]18A | | | S4 | S4 | S5 | S6 | S8 | S2 | S3 | S4 | 8 | 7 | 5 | 4 | 4 | 5 | 7 | |
| | | [12A]18B | | | S4 | S5 | S6 | S8 | S2 | S3 | S4 | S4 | 7 | 5 | 4 | 4 | 5 | 7 | 8 | 12 |

TABLE 3

| | | | | | | | | | | | | | | | | | | | | | | Inter- |
|---|---|---|---|---|---|---|---|---|---|---|---|---|---|---|---|---|---|---|---|---|---|---|
| | | | | | | | | | | | | | | | | | | | | | | Path |
| | | | | | | | | | | | | | | | | | | | | | | Euclid- |
| | | | | | | | | | | | | | | | | | | | | | | ean |
| State | Transition Data Stream | | k − | k − | k − | k − | k − | k − | k − | k − | k − | | | | | | | | | | | Dis- |
| Transition | (bₖ₋ᵢ, . . . , bₖ) | Pattern | 9 | 8 | 7 | 6 | 5 | 4 | 3 | 2 | 1 | k | PR Equalization Ideal Value | | | | | | | | | tance |
| S0ₖ₋₉ → S6ₖ | (0, 0, 0, 0, x, 1, !x, 0, | [12B]1A | S0 | S1 | S2 | S9 | S6 | S8 | S2 | S3 | S5 | S6 | 1 | 3 | 4 | 4 | 4 | 4 | 5 | 6 | 5 | |
| | x, 1, 1, 0, 0) | [12B]1B | S0 | S0 | S1 | S2 | S9 | S6 | S8 | S2 | S9 | S6 | 0 | 1 | 3 | 4 | 4 | 4 | 4 | 4 | 4 | 12 |
| S0ₖ₋₉ → S5ₖ | (0, 0, 0, 0, x, 1, !x, 0, | [12B]2A | S0 | S1 | S2 | S9 | S6 | S8 | S2 | S3 | S4 | S5 | 1 | 3 | 4 | 4 | 4 | 4 | 5 | 7 | 7 | |
| | x, 1, 1, 1, 0) | [12B]2B | S0 | S0 | S1 | S2 | S9 | S6 | S8 | S2 | S3 | S5 | 0 | 1 | 3 | 4 | 4 | 4 | 4 | 5 | 6 | 12 |
| S0ₖ₋₉ → S4ₖ | (0, 0, 0, 0, x, 1, !x, 0, | [12B]3A | S0 | S1 | S2 | S9 | S6 | S8 | S2 | S3 | S4 | S4 | 1 | 3 | 4 | 4 | 4 | 4 | 5 | 7 | 8 | |
| | x, 1, 1, 1, 1) | [12B]3B | S0 | S0 | S1 | S2 | S9 | S6 | S8 | S2 | S3 | S4 | 0 | 1 | 3 | 4 | 4 | 4 | 4 | 5 | 7 | 12 |
| S2ₖ₋₇ → S0ₖ | (0, 0, 1, 1, x, 0, !x, 1, | [12B]4A | S2 | S3 | S5 | S6 | S8 | S2 | S9 | S6 | S7 | S0 | 5 | 6 | 5 | 4 | 4 | 4 | 4 | 3 | 1 | |
| | x, 0, 0, 0, 0) | [12B]4B | S2 | S9 | S6 | S8 | S2 | S9 | S6 | S7 | S0 | S0 | 4 | 4 | 4 | 4 | 4 | 4 | 3 | 1 | 0 | 12 |
| S2ₖ₋₇ → S1ₖ | (0, 0, 1, 1, x, 0, !x, 1, | [12B]5A | S2 | S3 | S5 | S6 | S8 | S2 | S9 | S6 | S7 | S1 | 5 | 6 | 5 | 4 | 4 | 4 | 4 | 3 | 2 | |
| | x, 0, 0, 0, 1) | [12B]5B | S2 | S9 | S6 | S8 | S2 | S9 | S6 | S7 | S0 | S1 | 4 | 4 | 4 | 4 | 4 | 4 | 3 | 1 | 1 | 12 |
| S2ₖ₋₇ → S2ₖ | (0, 0, 1, 1, x, 0, !x, 1, | [12B]6A | S2 | S3 | S5 | S6 | S8 | S2 | S9 | S6 | S8 | S2 | 5 | 6 | 5 | 4 | 4 | 4 | 4 | 4 | 4 | |
| | x, 0, 0, 1, 1) | [12B]6B | S2 | S9 | S6 | S8 | S2 | S9 | S6 | S7 | S1 | S2 | 4 | 4 | 4 | 4 | 4 | 4 | 3 | 2 | 3 | 12 |
| S3ₖ₋₅ → S0ₖ | (0, 1, 1, 1, x, 0, !x, 1, | [12B]7A | S3 | S4 | S5 | S6 | S8 | S2 | S9 | S6 | S7 | S0 | 7 | 7 | 5 | 4 | 4 | 4 | 4 | 3 | 1 | |
| | x, 0, 0, 0, 0) | [12B]7B | S3 | S5 | S6 | S8 | S2 | S9 | S6 | S7 | S0 | S0 | 6 | 5 | 4 | 4 | 4 | 4 | 3 | 1 | 0 | 12 |
| S3ₖ₋₅ → S1ₖ | (0, 1, 1, 1, x, 0, !x, 1, | [12B]8A | S3 | S4 | S5 | S6 | S8 | S2 | S9 | S6 | S7 | S1 | 7 | 7 | 5 | 4 | 4 | 4 | 4 | 3 | 2 | |
| | x, 0, 0, 0, 1) | [12B]8B | S3 | S5 | S6 | S8 | S2 | S9 | S6 | S7 | S0 | S1 | 6 | 5 | 4 | 4 | 4 | 4 | 3 | 1 | 1 | 12 |
| S3ₖ₋₅ → S2ₖ | (0, 1, 1, 1, x, 0, !x, 1, | [12B]9A | S3 | S4 | S5 | S6 | S8 | S2 | S9 | S6 | S8 | S2 | 7 | 7 | 5 | 4 | 4 | 4 | 4 | 4 | 4 | |
| | x, 0, 0, 1, 1) | [12B]9B | S3 | S5 | S6 | S8 | S2 | S9 | S6 | S7 | S1 | S2 | 6 | 5 | 4 | 4 | 4 | 4 | 3 | 2 | 3 | 12 |
| S7ₖ₋₅ → S6ₖ | (1, 0, 0, 0, x, 1, !x, 0, | [12B]10A | S7 | S1 | S2 | S9 | S6 | S8 | S2 | S3 | S5 | S6 | 2 | 3 | 4 | 4 | 4 | 4 | 5 | 6 | 5 | |
| | x, 1, 1, 0, 0) | [12B]10B | S7 | S0 | S1 | S2 | S9 | S6 | S8 | S2 | S9 | S6 | 1 | 1 | 3 | 4 | 4 | 4 | 4 | 4 | 4 | 12 |
| S7ₖ₋₅ → S5ₖ | (1, 0, 0, 0, x, 1, !x, 0, | [12B]11A | S7 | S1 | S2 | S9 | S6 | S8 | S2 | S3 | S4 | S5 | 2 | 3 | 4 | 4 | 4 | 4 | 5 | 7 | 7 | |
| | x, 1, 1, 1, 0) | [12B]11B | S7 | S0 | S1 | S2 | S9 | S6 | S8 | S2 | S3 | S5 | 1 | 1 | 3 | 4 | 4 | 4 | 4 | 5 | 6 | 12 |
| S7ₖ₋₅ → S4ₖ | (1, 0, 0, 0, x, 1, !x, 0, | [12B]12A | S7 | S1 | S2 | S9 | S6 | S8 | S2 | S3 | S4 | S4 | 2 | 3 | 4 | 4 | 4 | 4 | 5 | 7 | 8 | |
| | x, 1, 1, 1, 1) | [12B]12B | S7 | S0 | S1 | S2 | S9 | S6 | S8 | S2 | S3 | S4 | 1 | 1 | 3 | 4 | 4 | 4 | 4 | 5 | 7 | 12 |
| S6ₖ₋₅ → S6ₖ | (1, 1, 0, 0, x, 1, !x, 0, | [12B]13A | S6 | S8 | S2 | S9 | S6 | S8 | S2 | S3 | S5 | S6 | 4 | 4 | 4 | 4 | 4 | 4 | 5 | 6 | 5 | |
| | x, 1, 1, 0, 0) | [12B]13B | S6 | S7 | S1 | S2 | S9 | S6 | S8 | S2 | S9 | S6 | 3 | 2 | 3 | 4 | 4 | 4 | 4 | 4 | 4 | 12 |
| S6ₖ₋₅ → S5ₖ | (1, 1, 0, 0, x, 1, !x, 0, | [12B]14A | S6 | S8 | S2 | S9 | S6 | S8 | S2 | S3 | S4 | S5 | 4 | 4 | 4 | 4 | 4 | 4 | 5 | 7 | 7 | |
| | x, 1, 1, 1, 0) | [12B]14B | S6 | S7 | S1 | S2 | S9 | S6 | S8 | S2 | S3 | S5 | 3 | 2 | 3 | 4 | 4 | 4 | 4 | 5 | 6 | 12 |
| S6ₖ₋₅ → S4ₖ | (1, 1, 0, 0, x, 1, !x, 0, | [12B]15A | S6 | S8 | S2 | S9 | S6 | S8 | S2 | S3 | S4 | S4 | 4 | 4 | 4 | 4 | 4 | 4 | 5 | 7 | 8 | |
| | 1) | [12B]15B | S6 | S7 | S1 | S2 | S9 | S6 | S8 | S2 | S3 | S4 | 3 | 2 | 3 | 4 | 4 | 4 | 4 | 5 | 7 | 12 |
| S4ₖ₋₅ → S0ₖ | (1, 1, 1, 1, x, 0, !x, 1, | [12B]16A | S4 | S4 | S5 | S6 | S8 | S2 | S9 | S6 | S7 | S0 | 8 | 7 | 5 | 4 | 4 | 4 | 4 | 3 | 1 | |
| | x, 0, 0, 0, 0) | [12B]16B | S4 | S5 | S6 | S8 | S2 | S9 | S6 | S7 | S0 | S0 | 7 | 5 | 4 | 4 | 4 | 4 | 3 | 1 | 0 | 12 |
| S4ₖ₋₅ → S1ₖ | (1, 1, 1, 1, x, 0, !x, 1, | [12B]17A | S4 | S4 | S5 | S6 | S8 | S2 | S9 | S6 | S7 | S1 | 8 | 7 | 5 | 4 | 4 | 4 | 4 | 3 | 2 | |
| | x, 0, 0, 0, 1) | [12B]17B | S4 | S5 | S6 | S8 | S2 | S9 | S6 | S7 | S0 | S1 | 7 | 5 | 4 | 4 | 4 | 4 | 3 | 1 | 1 | 12 |
| S4ₖ₋₅ → S2ₖ | (1, 1, 1, 1, x, 0, !x, 1, | [12B]18A | S4 | S4 | S5 | S6 | S8 | S2 | S9 | S6 | S8 | S2 | 8 | 7 | 5 | 4 | 4 | 4 | 4 | 4 | 4 | |
| | x, 0, 0, 1, 1) | [12B]18B | S4 | S5 | S6 | S8 | S2 | S9 | S6 | S7 | S1 | S2 | 7 | 5 | 4 | 4 | 4 | 4 | 3 | 2 | 3 | 12 |

In Tables 1 through 3, the first column represents the state transition (Sm_{k 9}→Snₖ) by which two state transitions which are likely to cause an error are branched and rejoin.

The second column represents the state data stream (bₖ₋₁, . . . , bₖ) which causes the corresponding state transition.

“X” in the demodulated data stream represents a bit which is highly likely to cause an error in such data. When the corresponding state transition is determined to be an error, the number of X's (also the number of !X's) is the number of errors.

Among a transition data stream in which X is 1 and a transition data stream in which X is 0, one corresponds to a first state transition matrix having the maximum likelihood, and the other corresponds to a second state transition matrix having the second maximum likelihood.

In Tables 2 and 3, “!X” represents an inverted bit of X.

From the demodulated data streams obtained by demodulation performed by a Viterbi decoding section, the first state transition matrix having the maximum likelihood of causing an error and the second state transition matrix having the second maximum likelihood of causing an error can be extracted by comparing each demodulated data stream and the transition data stream (X: Don't care).

The third column represents the first state transition matrix and the second state transition matrix.

The fourth column represents two ideal reproduction waveforms (PR equalization ideal values) after the respective state transitions. The fifth column represents the square of the Euclidean distance between the two ideal signals (inter-path Euclidean distance).

Among combination patterns of two possible state transitions, Table 1 shows 18 patterns by which the square of the Euclidean distance between the two possible state transitions is 14. These patterns correspond to a portion of an optical disc medium at which a mark is switched to a space (edge of a waveform). In other words, these patterns are 1-bit edge shift error patterns.

As an example, state transition paths from S0(k−5) to S6(k) in the state transition rule in FIG. 9 will be described. In this case, one path in which the recording stream is changed as “0,0,0,0,1,1,1,0,0” is detected. Considering that “0” of the reproduction data is a space and “1” of the reproduction data is a mark, this state transition path corresponds to a 4T or longer space, a 3T mark, and a 2T or longer space.

FIG. 10 shows an example of the PR equalization ideal waveforms in the recording stream shown in Table 1. In FIG. 10, “A path waveform” represents the PR equalization ideal waveform of the above-mentioned recording stream.

Similarly, FIG. 11 shows an example of the PR equalization ideal waveforms shown in Table 2.

FIG. 12 shows an example of the PR equalization ideal waveforms shown in Table 3.

In FIGS. 10, 11 and 12, the horizontal axis represents the sampling time (sampled at one time unit of the recording stream), and the vertical axis represents the reproduction signal level.

As described above, in PR12221ML, there are 9 ideal reproduction signal levels (level 0 through level 8).

In the state transition rule shown in FIG. 9, there is another path from S0(k−5) to S6(k), in which the recording stream is changed as “0,0,0,0,0,1,1,0,0”. Considering that “0” of the reproduction data is a space and “1” of the reproduction data is a mark, this state transition path corresponds to a 5T or longer space, a 2T mark, and a 2T or longer space.

In FIG. 10, “B path waveform” represents the PR equalization ideal waveform of this path.

The patterns shown in Table 1 corresponding to the Euclidean distance of 14 have a feature of necessarily including one piece of edge information.

Table 2 shows 18 patterns by which the square of the Euclidean distance between the two possible state transitions is 12.

These patterns correspond to a shift error of a 2T mark or a 2T space; namely, are 2-bit shift error patterns.

As an example, state transition paths from S0(k−7)to S0(k) in the state transition rule in FIG. 9 will be described.

In this case, one path in which the recording stream is changed as “0,0,0,0,1,1,0,0,0,0,0” is detected. Considering that “0” of the reproduction data is a space and “1” of the reproduction data is a mark, this state transition path corresponds to a 4T or longer space, a 2T mark, and a 5T or longer space.

In FIG. 11, “A path waveform” represents the PR equalization ideal waveform of this path.

There is another path in which the recording stream is changed as “0,0,0,0,0,1,1,0,0,0,0”. Considering that “0” of the reproduction data is a space and “1” of the reproduction data is a mark, this state transition path corresponds to a 5T or longer space, a 2T mark, and a 4T or longer space.

In FIG. 11, “B path waveform” represents the PR equalization ideal waveform of this path.

The patterns shown in Table 2 corresponding to the Euclidean distance of 12 have a feature of necessarily including two pieces of edge information on a 2T rise and a 2T fall.

Table 3 also shows 18 patterns by which the square of the Euclidean distance between two possible state transitions is 12. The patterns in Table 3 is of a different type from the patterns in Table 2.

These patterns correspond to a portion at which a 2T mark is continuous to a 2T space; namely, are 3-bit error patterns.

As an example, state transition paths from S0(k−9)to S6(k) in the state transition rule in FIG. 9 will be described.

In this case, one path in which the recording stream is changed as “0,0,0,0,1,1,0,0,1,1,1,0,0” is detected. Considering that “0” of the reproduction data is a space and “1” of the reproduction data is a mark, this state transition path corresponds to a 4T or longer space, a 2T mark, a 2T space, a 3T mark, and a 2T or longer space.

In FIG. 12, “A path waveform” represents the PR equalization ideal waveform of this path.

There is another path in which the recording stream is changed as “0,0,0,0,0,1,1,0,0,1,1,0,0”. Considering that “0” of the reproduction data is a space and “1” of the reproduction data is a mark, this state transition path corresponds to a 5T or longer space, a 2T mark, a 2T space, a 2T mark, and a 2T or longer space.

In FIG. 12, “B path waveform” represents the PR equalization ideal waveform of this path.

The patterns shown in Table 3 corresponding to the square of the Euclidean distance of 12 have a feature of including at least three pieces of edge information.

As shown in FIG. 7, an edge shift detection section 10 includes a 14-pattern detection section 701, a 12A-pattern detection section 704 and a 12B-pattern detection section 707 for respectively detecting patterns corresponding to Table 1 (14-patterns), Table 2 (12A-patterns) and Table 3 (12B-patterns); differential metric calculation sections 702, 705 and 708 for calculating a metric difference of each pattern; and memory sections 703, 706, and 709 for accumulating and storing a positional shift index of each pattern calculated by the differential metric calculation sections. The PR equalization section 8 has a frequency characteristic which is set such that the frequency characteristic of the reproduction system is the PR(1,2,2,2,1) equalization characteristic.

The pattern detection sections 701, 704 and 707 compare the transition data streams in Tables 1, 2 and 3 with the binary data. When the binary data matches the transition data streams in Tables 1, 2 and 3, the pattern detection sections 701, 704 and 707 select a state transition matrix 1 having the maximum likelihood and a state transition matrix 2 having the second maximum likelihood based on Tables 1, 2 and 3.

Based on the selection results, the differential metric calculation sections 702, 705 and 708 calculate a metric, which is a distance between an ideal value of each state transition matrix (PR equalization ideal value; see Tables 1, 2 and 3) and the digital reproduction signal, and also calculate a difference between the metrics calculated based on the two state transition matrices. Such a metric difference has a positive or a negative value, and therefore is subjected to absolute value processing.

Based on the binary data, the pattern detection sections 701, 704 and 707 generate a pulse signal to be assigned to each of leading edge/trailing edge patterns of the mark shown in FIGS. 13, 14 and 15, and output the pulse signal to the memory sections 703, 706 and 709.

Based on the pulse signal output from the pattern detection sections 701, 704 and 707, the memory sections 703, 706 and 709 accumulatively add the metric differences obtained by the differential metric calculation sections 702, 705 and 708 for each pattern shown in FIGS. 13, 14 and 15.

Now, the detailed pattern classification in FIGS. 13, 14 and 15 will be described in detail.

In FIGS. 13, 14 and 15, symbols M and S represent the time series of marks and spaces shown in FIG. 6. Symbol !2Tm indicates that the recording mark is a mark other than a 2T mark (for example, is a 3T mark) . Similarly, a space other than a 2T space is indicated by !2Ts. Symbol xTm represents a recording mark having an arbitrary length, and symbol xTs represents a space having an arbitrary length. In the case of the RLL(1,7) recording code, the recording marks and the spaces have a length of 2T through 8T. Each pattern number corresponds to the pattern number in Tables 1, 2 and 3.

By the detailed pattern classification of the 14-detection patterns in FIG. 13, one edge shift of one space and one mark is classified. The “start” of a 14-detection pattern indicates an edge shift of a mark at time i and a space at time i−1. The “end” of a 14-detection pattern indicates an edge shift of a mark at time i and a space at time i+1.

By the detailed pattern classification of the 12A-detection patterns in FIG. 14, a shift of a 2T mark or a 2T space in a 14-detection pattern shown in FIG. 13 is further classified by the mark or space at the immediately previous time or the immediately subsequent time.

In the “start” of the 12A-detection pattern, a shift of a 2T mark at time i sandwiched between a space at time i−1 and a space at time i+1 is classified by the length of the space at time i+1, or a shift of a 2T space at time i−1 sandwiched between a mark at time i and a mark at time i−2 is classified by the length of the mark at time i−2. In the “end” of the 12A-detection pattern, a shift of a 2T mark at time i sandwiched between a space at time i−1 and a space at time i+1 is classified by the length of the space at time i−1, or a shift of a 2T space at time i+1 sandwiched between a mark at time i and a mark at time i+2 is classified by the length of the mark at time i+2.

Finally, by the detailed pattern classification of the 12B-detection patterns in FIG. 15, a shift of continuous 2T mark and 2T space in a 12A-detection pattern shown in FIG. 14 is further classified by the mark or space at the further immediately previous time or the further immediately subsequent time. Namely, a shift of a 2T mark and a 2T space located in succession and sandwiched between one mark and one space is classified.

In the “start” of the 12B-detection pattern, a shift of a 2T mark at time i and a 2T space at time i+1 sandwiched between a mark at time i+2 and a space at time i−1 is classified by the length of the mark at time i+2, or a shift of a 2T mark at time i−2 and a 2T space at time i+1 sandwiched between a space at time i−3 and a mark at time i is classified by the length of the mark at time i−3.

In the “end” of the 12B-detection pattern, a shift of a 2T mark at time i and a 2T space at time i−1 sandwiched between a space at time i+1 and a mark at time i−2 is classified by the length of the mark at time i−2, or a shift of a 2T space at time i+1 and a 2T mark at time i+2 sandwiched between a mark at time i and a space at time i+3 is classified by the length of the mark at time i+3.

Owing to the apparatus shown in FIG. 7, it is now possible to provide an index representing a positional shift of a set of one mark and one space including three edge shifts, i.e., a shift of the mark itself including two edge shifts and a shift of the space itself, in addition to a positional shift between a mark and a space including one edge shift.

Thus, when a pattern including a plurality of edge shifts is detected, how the edges are shifted with respect to the path having the maximum likelihood can be determined. Accordingly, the recording quality can be evaluated, and a pattern having a high error rate can be distinguished.

As described above, in high density recording, recording adjustment needs to be performed in consideration of a plurality of edge shifts, namely, edges of a plurality of marks and spaces. Therefore, it is not sufficient to consider recording conditions focusing on one edge as in the conventional art, and it is necessary to consider recording conditions also compatible to a higher-order PRML system.

### SUMMARY OF THE INVENTION

The present invention has an object of providing a recording control apparatus, a recording and reproduction apparatus, a recording control method, and a recording and reproduction method for optimizing a recording parameter at the time of information recording in consideration of a high-order PRML system such that the probability of errors in maximum likelihood decoding is minimized. More specifically, the present invention has an object of providing a recording control apparatus, a recording and reproduction apparatus, a recording control method, and a recording and reproduction method which, when high density recording requiring a high-order PRML system is performed on an information recording medium capable of storing information, are capable of performing recording such that the error rate of the recording information is reduced so as to realize a more stable recording and reproduction system. The recording control apparatus, the recording and reproduction apparatus, the recording control method, and the recording and reproduction method for achieving the above objectives are structured as described in items 1 through 28 below.

1. A recording control apparatus, according to the present invention, for recording information on an information recording medium, comprising:

a recording compensation parameter determination section for classifying recording conditions by data pattern, including at least one recording mark and at least one space, of a data stream to be recorded;

wherein the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space.

2. The recording control apparatus of item 1, wherein the classification using the length of the second recording mark is performed only when the length of the first space is equal to or less than a prescribed length.

3. The recording control apparatus of item 1 or 2, wherein the classification by data pattern is further performed using the length of a second space which is not located adjacent to the first recording mark or the first space and is located adjacent to the second recording mark.

4. The recording control apparatus of item 3, wherein the classification using the length of the second space is performed only when the length of the second recording mark is equal to or less than the prescribed length.

5. The recording control apparatus of item 2 or 4, wherein the prescribed length is the shortest length in the data stream.

6. A recording control apparatus, according to the present invention, for recording information on an information recording medium, comprising:

a recording compensation parameter determination section for classifying recording conditions by data pattern, including at least one recording mark and at least one space, of a data stream to be recorded;

wherein the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

7. The recording control apparatus of item 6, wherein the classification using the length of the second space is performed only when the length of the first recording mark is equal to or less than the prescribed length.

8. The recording control apparatus of item 6 or 7, wherein the classification by data pattern is further performed using the length of a second recording mark which is not located adjacent to the first recording mark or the first space and is located adjacent to the second space.

9. The recording control apparatus of item 8, wherein the classification using the length of the second recording mark is performed only when the length of the second space is equal to or less than the prescribed length.

10. The recording control apparatus of item 7 or 9, wherein the prescribed length is the shortest length in the data stream.

11. A recording control method, according to the present invention, for recording information on an information recording medium, by which:

recording conditions are classified by data pattern, including at least one recording mark and at least one space, of a data stream to be recorded;

the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space.

12. The recording control apparatus of item 11, wherein the classification using the length of the second recording mark is performed only when the length of the first space is equal to or less than a prescribed length.

13. The recording control apparatus of item 11 or 12, wherein the classification by data pattern is further performed using the length of a second space which is not located adjacent to the first recording mark or the first space and is located adjacent to the second recording mark.

14. The recording control apparatus of item 13, wherein the classification using the length of the second space is performed only when the length of the second recording mark is equal to or less than the prescribed length.

15. The recording control apparatus of item 12 or 14, wherein the prescribed length is the shortest length in the data stream.

16. A recording control method, according to the present invention, for recording information on an information recording medium, by which:

recording conditions are classified by data pattern, including at least one recording mark and at least one space, of a data stream to be recorded;

the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

17. The recording control apparatus of item 16, wherein the classification using the length of the second space is performed only when the length of the first recording mark is equal to or less than the prescribed length.

18. The recording control apparatus of item 16 or 17, wherein the classification by data pattern is further performed using the length of a second recording mark which is not located adjacent to the first recording mark or the first space and is located adjacent to the second space.

19. The recording control apparatus of item 18, wherein the classification using the length of the second recording mark is performed only when the length of the second space is equal to or less than the prescribed length.

20. The recording control apparatus of item 17 or 19, wherein the prescribed length is the shortest length in the data stream.

21. A recording and reproduction apparatus according to the present invention: comprising a reproduction signal processing section for generating a digital signal and decoding the digital signal into a binary signal, from a signal reproduced from an information recording medium using a PRML signal processing system; and a recording control section for adjusting a recording parameter for recording information on the information recording medium based on the digital signal and the binary signal and recording the information on the information recording medium;

wherein:

the recording control section includes a recording compensation parameter determination section for classifying recording conditions by data pattern, including at least one recording mark and at least one space, of a data stream to be recorded; and

the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space.

22. A recording and reproduction apparatus according to the present invention, comprising:

a reproduction signal processing section for generating a digital signal and decoding the digital signal into a binary signal, from a signal reproduced from an information recording medium using a PRML signal processing system; and

a recording control section for adjusting a recording parameter for recording information on the information recording medium based on the digital signal and the binary signal and recording the information on the information recording medium;

wherein:

the recording control section includes a recording compensation parameter determination section for classifying recording conditions by data pattern, including at least one recording mark and at least one space, of a data stream to be recorded; and

the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

23. The recording and reproduction apparatus of item 21 or 22, wherein:

the reproduction signal processing section includes an edge shift detection section for calculating, from the binary signal, a differential metric which is a difference of a reproduction signal from a first state transition matrix having a maximum likelihood and a second state transition matrix having a second maximum likelihood, assigning the differential metric to each of leading edge/trailing edge patterns of the recording marks based on the binary signal, and finding an edge shift of the recording parameter from an optimal value for each pattern; and

the recording parameter is adjusted such that the edge shift approaches a prescribed target value.

24. The recording and reproduction apparatus of item 23, wherein the classification by data pattern obtained in the recording compensation parameter determination step and the classification by pattern obtained in the edge shift detection step are the same.

25. A recording and reproduction method according to the present invention, comprising:

a reproduction signal processing step of generating a digital signal and decoding the digital signal into a binary signal, from a signal reproduced from an information recording medium using a PRML signal processing system; and

a recording control step of adjusting a recording parameter for recording information on the information recording medium based on the digital signal and the binary signal and recording the information on the information recording medium;

wherein:

the recording control step includes a recording compensation parameter determination step of classifying recording conditions by data pattern, including at least one recording mark and at least one space, of a data stream to be recorded, the data pattern; and

the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space. 26. A recording and reproduction method according to the present invention, comprising:

a reproduction signal processing step of generating a digital signal and decoding the digital signal into a binary signal, from a signal reproduced from an information recording medium using a PRML signal processing system; and

a recording control step of adjusting a recording parameter for recording information on the information recording medium based on the digital signal and the binary signal and recording the information on the information recording medium;

wherein:

the recording control step includes a recording compensation parameter determination step of classifying recording conditions by data pattern, including at least one recording mark and at least one space, of a data stream to be recorded, the data pattern; and

the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

27. The recording and reproduction method of item 25 or 26, wherein:

the reproduction signal processing step includes an edge shift detection step of calculating, from the binary signal, a differential metric which is a difference of a reproduction signal from a first state transition matrix having a maximum likelihood and a second state transition matrix having a second maximum likelihood, assigning the differential metric to each of leading edge/trailing edge patterns of the recording marks based on the binary signal, and finding an edge shift of the recording parameter from an optimal value for each pattern; and

the recording parameter is adjusted such that the edge shift approaches a prescribed target value.

28. The recording and reproduction method of item 27, wherein the classification by data pattern obtained in the recording compensation parameter determination step and the classification by pattern obtained in the edge shift detection step are the same.

By controlling recording conditions by a recording control apparatus, a recording and reproduction apparatus, a recording control method, and a recording and reproduction method according to the present invention, the error rate of the recording information can be reduced in high density recording which requires a high-order PRML system, and thus a more stable recording and reproduction system can be provided.

### BRIEF DESCRIPTION OF THE DRAWINGS

FIG. 1 shows an information recording and reproduction apparatus according to the present invention.

FIG. 2 shows recording pulse waveform and recording powers.

FIG. 3 shows recording pulse shapes.

FIG. 4 shows a conventional recording control apparatus.

FIG. 5 shows conventional recording parameter tables.

FIG. 6 shows a time series of recording marks and spaces.

FIG. 7 shows a signal evaluation apparatus using the PR12221ML system.

FIG. 8 shows a state transition rule defined by the RLL(1,7) recording code and the equalization system PR(1,2,2,2,1) according to an embodiment of the present invention.

FIG. 9 is a trellis diagram corresponding to the state transition rule shown in FIG. 8.

FIG. 10 shows PR equalization ideal waveforms shown in Table 1.

FIG. 11 shows PR equalization ideal waveforms shown in Table 2.

FIG. 12 shows PR equalization ideal waveforms shown in Table 3.

FIG. 13 shows classification into detailed patterns of differential metrics having a 14-detection pattern by PR(1,2,2,2, 1)ML.

FIG. 14 shows classification into detailed patterns of differential metrics having a 12A-detection pattern by PR(1,2,2,2,1)ML.

FIG. 15 shows classification into detailed patterns of differential metrics having a 12B-detection pattern by PR (1, 2, 2, 2, 1) ML.

FIG. 16 shows a pattern table according to an embodiment of the present invention.

FIG. 17 shows recording pulses corresponding to the pattern table shown in FIG. 16.

FIG. 18 shows a pattern table according to an embodiment of the present invention.

FIG. 19 shows recording pulses corresponding to the pattern table shown in FIG. 18.

FIG. 20 shows a pattern table according to an embodiment of the present invention.

FIG. 21 shows recording pulses corresponding to the pattern table shown in FIG. 20.

FIG. 22 shows a pattern table according to an embodiment of the present invention.

FIG. 23 shows recording pulses corresponding to the pattern table shown in FIG. 22.

FIG. 24 shows a pattern table according to an embodiment of the present invention.

FIG. 25 shows recording pulses corresponding to the pattern table shown in FIG. 24.

FIG. 26 shows a pattern table according to an embodiment of the present invention.

FIG. 27 shows recording pulses corresponding to the pattern table shown in FIG. 26.

FIG. 28 shows a pattern table according to an embodiment of the present invention.

FIG. 29 shows recording pulses corresponding to the pattern table shown in FIG. 28.

FIG. 30 shows a pattern table according to an embodiment of the present invention.

FIG. 31 shows recording pulses corresponding to the pattern table shown in FIG. 30.

### DETAILED DESCRIPTION OF PREFERRED EMBODIMENTS

Hereinafter, embodiments of the present invention will be described with reference to the drawings. Identical elements bear identical reference numerals, and identical descriptions thereof will be omitted.

First, a table of a recording parameter, which is a recording condition in this embodiment (hereinafter, referred to as the “pattern table”) will be described. The recording condition is a recording pulse condition in this embodiment, but may be another recording parameter such as a recording power condition or the like. In this embodiment, the PR12221ML system is adopted for signal processing of a reproduction system, and RLL (Run Length Limited) code such as the RLL(1,7) code is used as the recording code.

<Pattern Table 1-1 Regarding the Leading Edge>

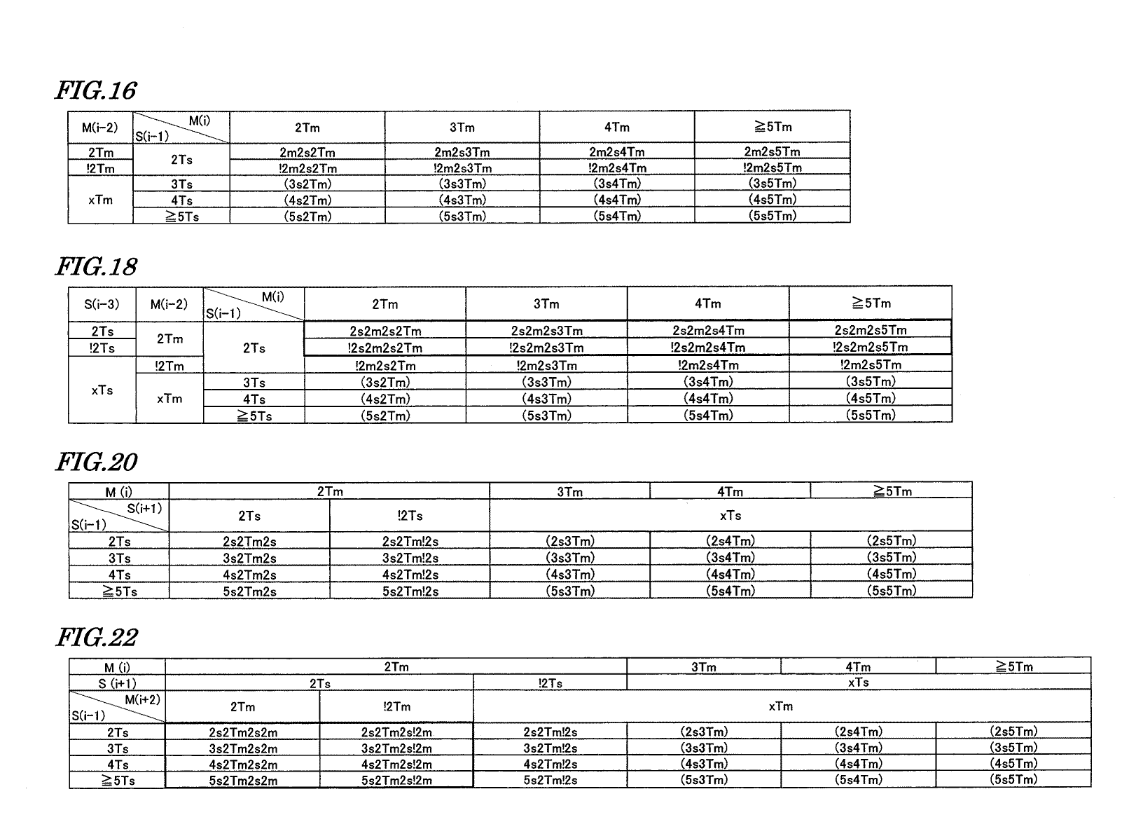

Table 1 of the recording parameter regarding the leading edge of a recording mark is shown in FIG. 16. A feature of Table 1 is that when the space immediately previous to the recording mark is the shortest space, the recording parameter is set differently in accordance with the length of the recording mark immediately previous to the space. All the recording marks are the target of the pattern table.

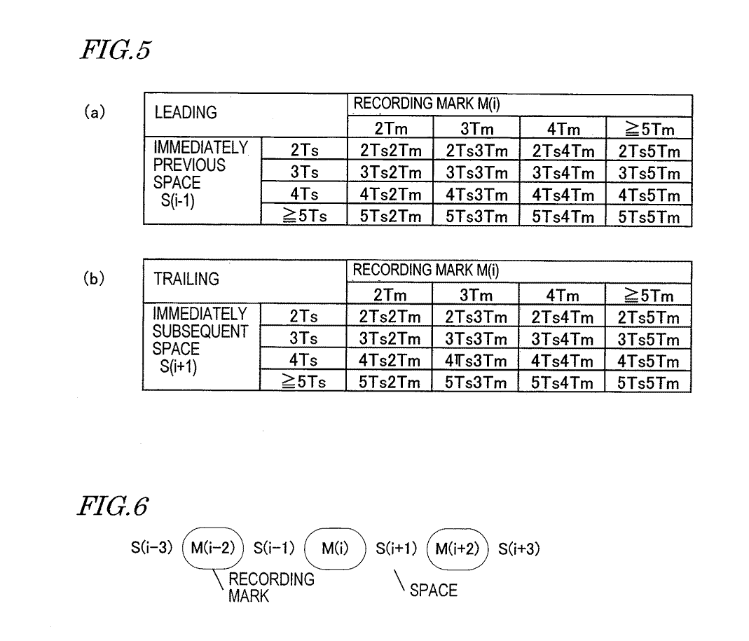

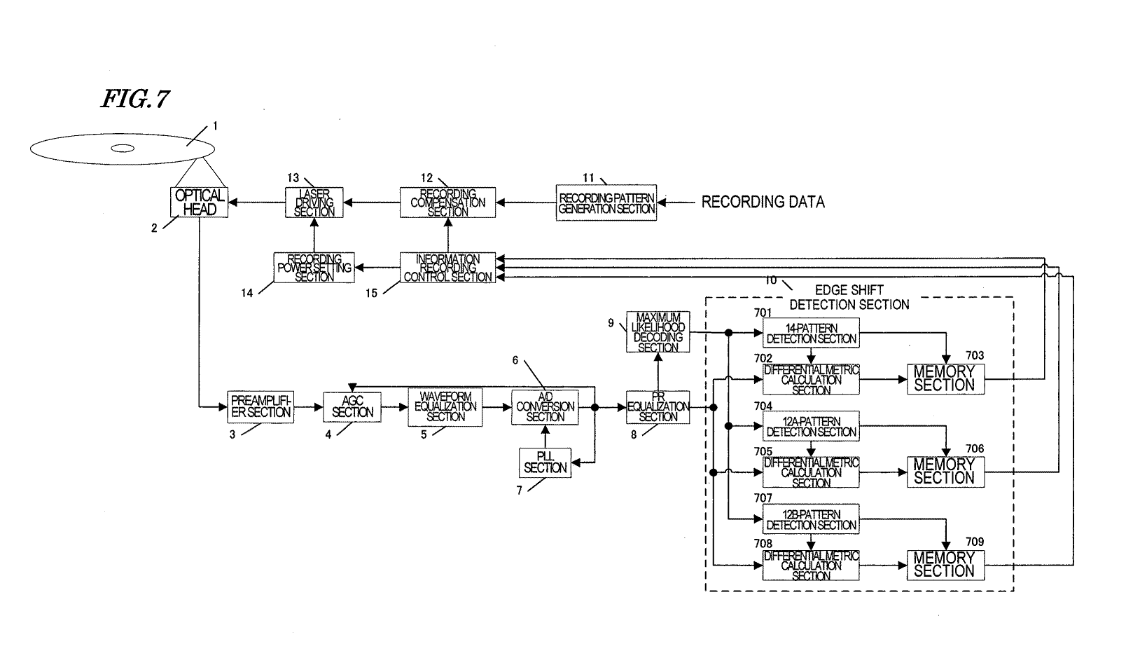

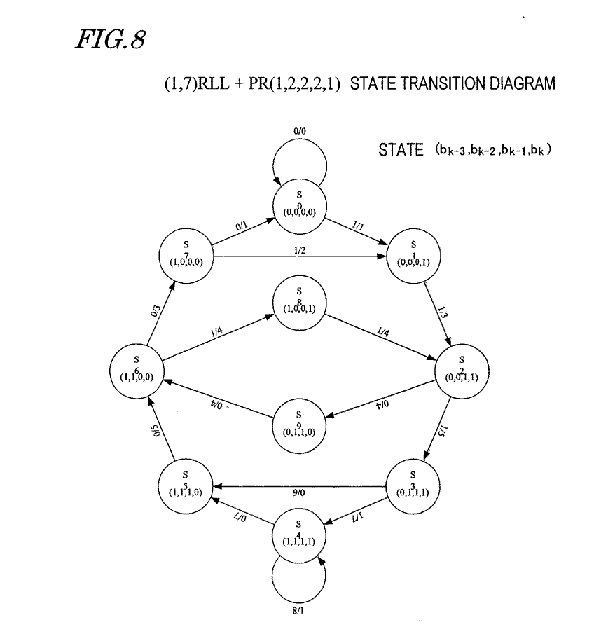

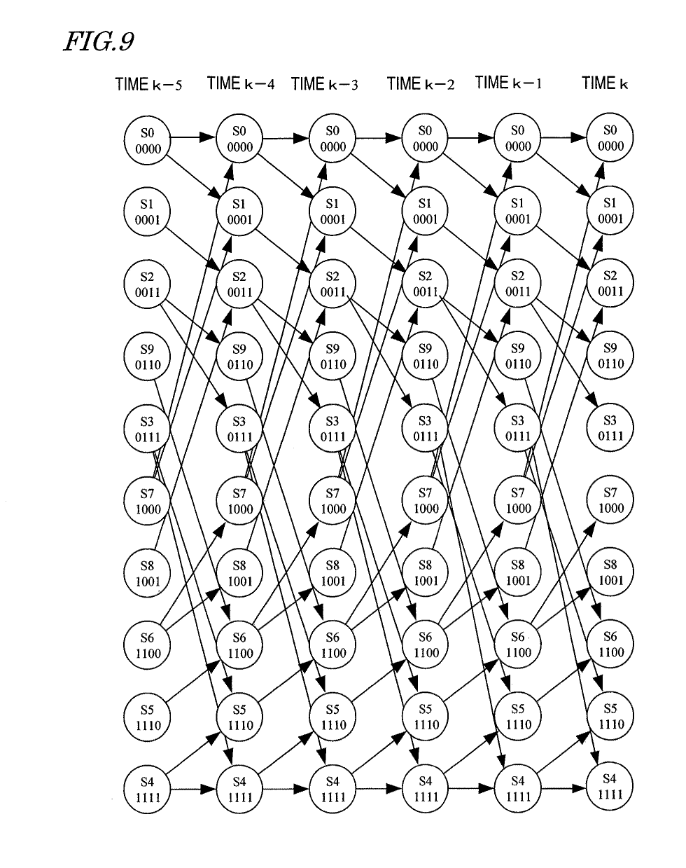

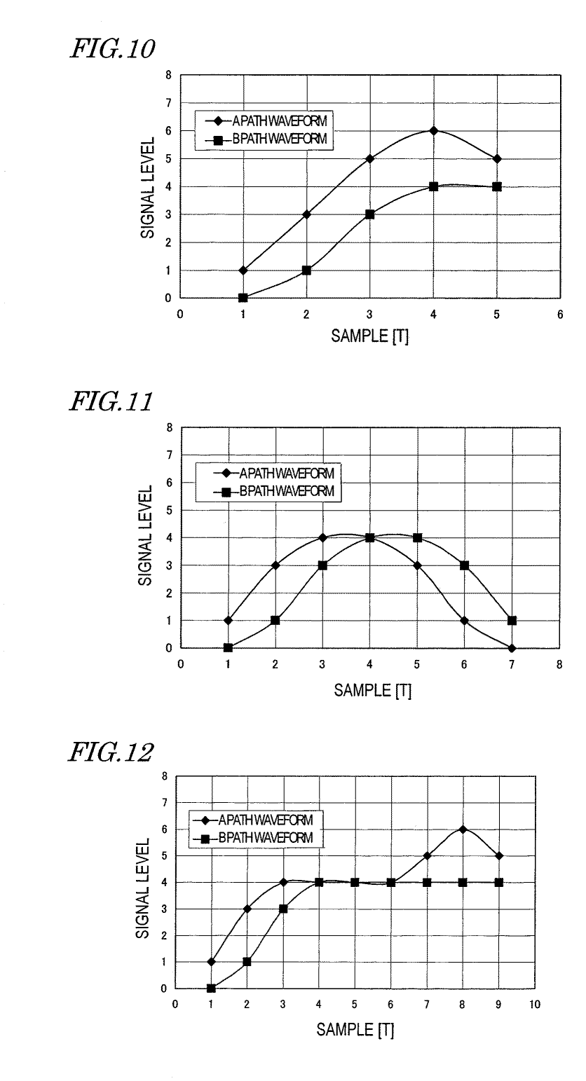

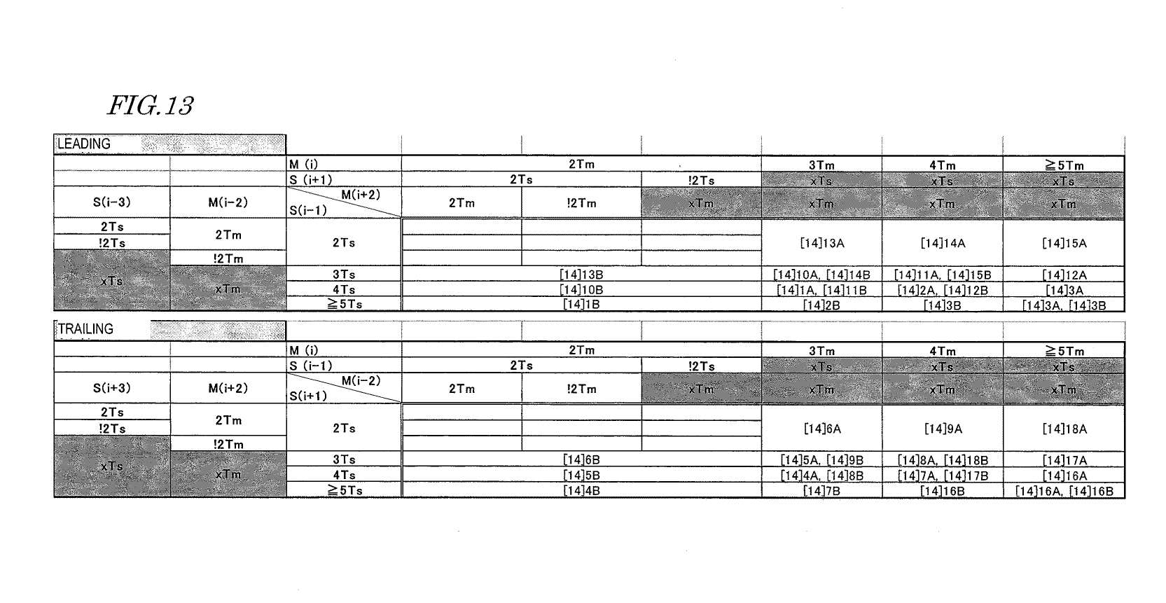

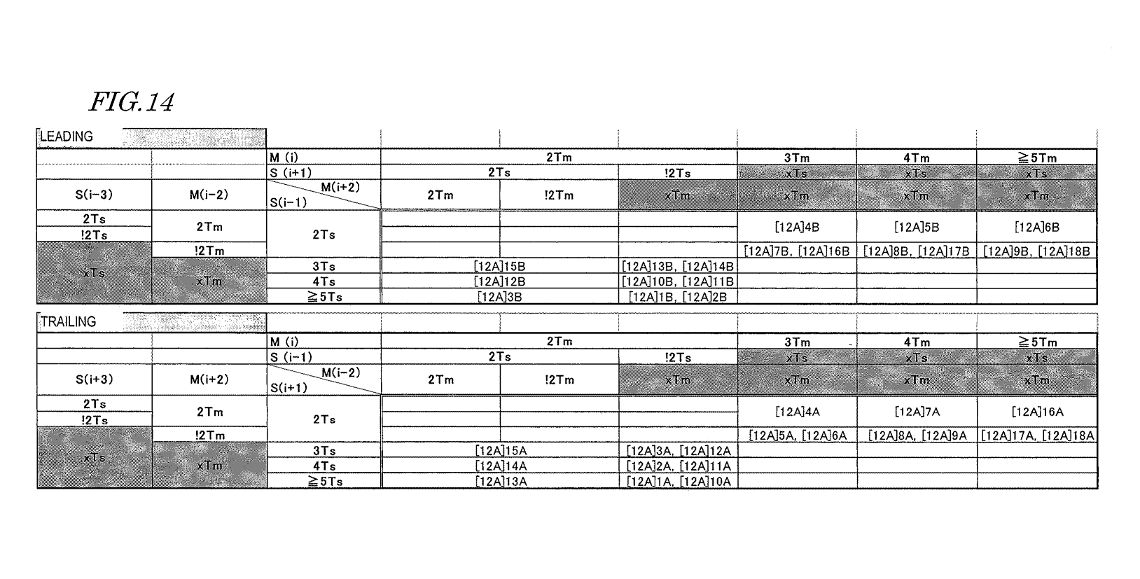

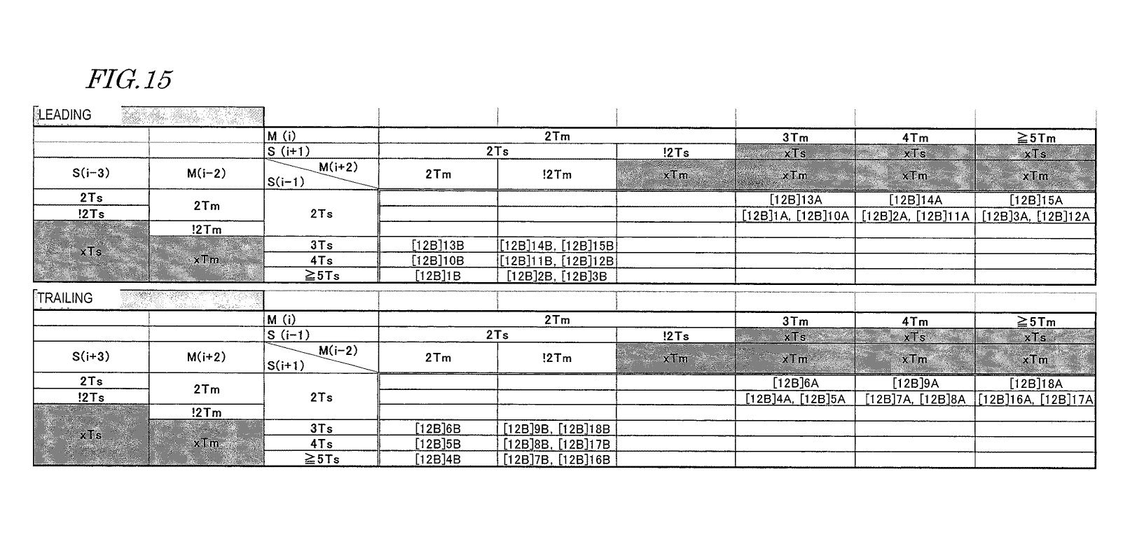

In FIG. 16, a recording mark as the target of the recording parameter is represented by recording mark M(i) as in FIG. 5 and FIG. 6 shown above. The other spaces and recording marks are also represented by the same symbols. In FIG. 16, symbol !2Tm in M(i−2) indicates that the recording mark is a mark other than a 2T mark (for example, is a 3T mark). Similarly, a space other than a 2T space is indicated by !2Ts. Symbol xTm indicates that it is not necessary to limit the length of the recording mark. Similarly in the following description, symbol xTs indicates that it is not necessary to limit the length of the space. It is noted that in the case of the RLL(1,7) code, the length of the recording mark and the space is 2T through 8T.

Now, symbols different from those in FIG. 5 will be described. In this embodiment, the representation of the relationship between a recording mark and a space or a recording mark previous thereto or subsequent thereto in the pattern table is complicated. Therefore, in a representation of each pattern, T is added only to the recording mark M(i) which is the target of the recording parameter. For example, when the immediately previous space S(i−1) is a 3T space and the recording mark M(i) is a 2T mark, the pattern is represented as pattern 3s2Tm. A pattern represented in the same manner as in FIG. 5 is provided with parentheses. Accordingly, pattern 3s2Tm is represented as pattern (3s2Tm). Such symbols are applied in the other pattern tables described later.

It is understood that the pattern table in FIG. 16 is the same as the conventional pattern table in FIG. 5 in the case where the immediately previous space is a space other than the shortest space, i.e., a 3T or longer space. Only in the case where the immediately previous space S(i−1) is the shortest space, the pattern representation varies in accordance with the length of the mark M(i−1) immediately previous to the shortest space. Namely, in this case, the recording parameter is set differently in accordance with the difference in the length of the mark immediately previous to the shortest space.

One reason is that the influence of thermal interference is largest when the immediately previous space is the shortest space. Another reason is that the shortest mark is extremely short in high density recording. In a recording and reproduction system for BD, the length of the shortest mark and the shortest space is about 149 nm in the case of the 25 GB recording, and about 112 nm in the case of the 33.4 GB recording. The size of the beam spot is about 250 nm. In the case of the 33.4 GB recording, even the pattern 2m2s including the shortest mark and the shortest space in continuation is encompassed in the beam spot. In high density recording, as the recording mark length is shorter, the expansion of the recording mark in the width direction is also extremely reduced. When the shortest mark is formed, the heat amount accumulated in the recording film is smallest and so the heat amount given to the next recording mark is also small. Therefore, in this embodiment, the recording parameter is set differently in accordance with the difference in the length of the mark immediately previous to the shortest space, so that a more appropriate recording mark can be formed in high density recording.

In this embodiment, the length of the immediately previous mark is classified as the shortest mark 2Tm which is most liable to be influenced by the thermal interference or recording marks of the other lengths !2Tm. This is performed in consideration of the scale of the circuit having the recording parameter. In the case where the circuit scale can be ignored, it is desirable that a recording mark of 3T mark or longer can be set differently.

Especially in the case where the recording mark M(i) is a 3T mark or longer, when the immediately previous recording mark is the shortest mark 2Tm, the recording condition regarding the 12B patterns described above (more strictly, 2T continuous patterns including the 12B patterns) is applied. When the immediately previous recording mark is other than the shortest mark, i.e., !2Tm, the recording condition regarding the 12A patterns described above is applied. In this manner, the recording adjustment can be made with the 12A patterns and the 12B patterns being separated.

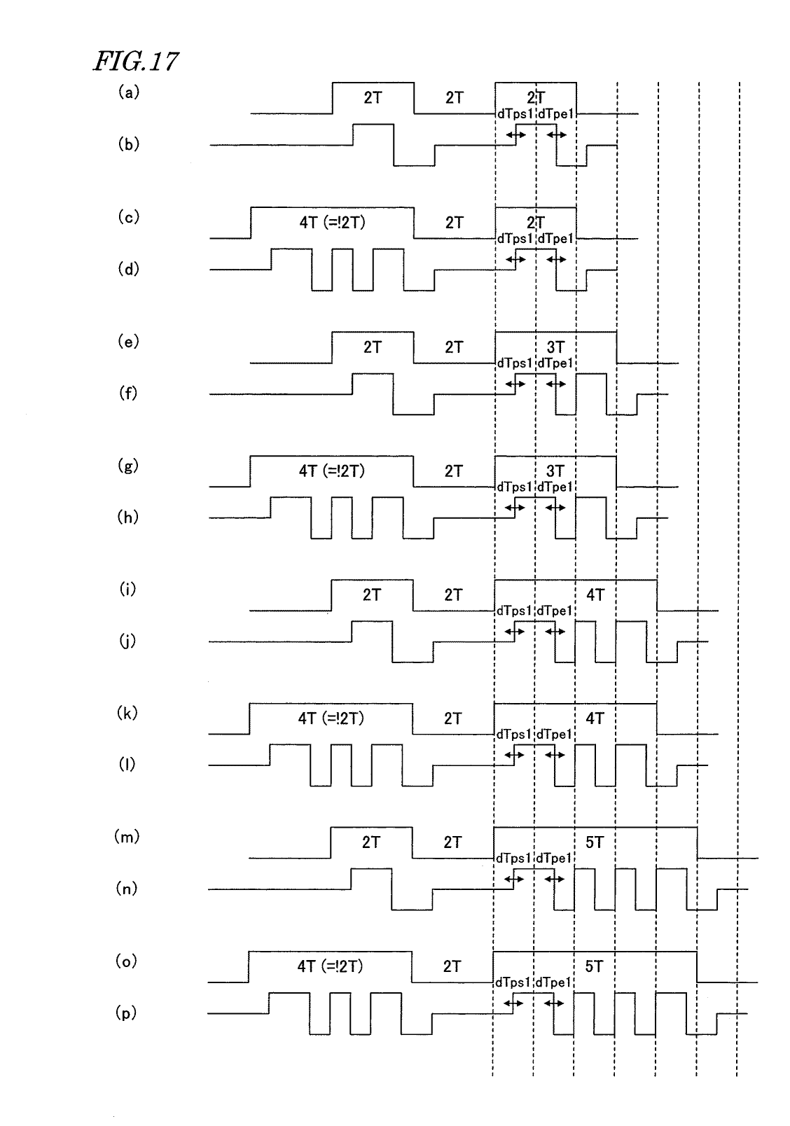

FIG. 17 shows recording pulses corresponding to different recording parameters regarding the leading edge of a recording mark in the case where the immediately previous space is the shortest space.

FIG. 17(a) shows an NRZI signal of pattern 2m2s2Tm, and FIG. 17(b) shows a recording pulse for the NRZI signal of pattern 2m2s2Tm;

FIG. 17(c) shows an NRZI signal of pattern 4m2s2Tm, and FIG. 17(d) shows a recording pulse for the NRZI signal of pattern 4m2s2Tm;

FIG. 17(e) shows an NRZI signal of pattern 2m2s3Tm, and FIG. 17(f) shows a recording pulse for the NRZI signal of pattern 2m2s3Tm;

FIG. 17(g) shows an NRZI signal of pattern 4m2s3Tm, and FIG. 17(h) shows a recording pulse for the NRZI signal of pattern 4m2s3Tm;

FIG. 17(i) shows an NRZI signal of pattern 2m2s4Tm, and FIG. 17(j) shows a recording pulse for the NRZI signal of pattern 2m2s4Tm;

FIG. 17(k) shows an NRZI signal of pattern 4m2s4Tm, and FIG. 17(l) shows a recording pulse for the NRZI signal of pattern 4m2s4Tm;

FIG. 17(m) shows an NRZI signal of pattern 2m2s5Tm, and FIG. 17(n) shows a recording pulse for the NRZI signal of pattern 2m2s5Tm; and

FIG. 17(o) shows an NRZI signal of pattern 4m2s5Tm, and FIG. 17(p) shows a recording pulse for the NRZI signal of pattern 4m2s5Tm.

The recording mark as the target of the recording parameter setting is: in FIG. 17(a) and FIG. 17(c), a 2T mark; in FIG. 17(e) and FIG. 17(g), a 3T mark; in FIG. 17(i) and FIG. 17(k), a 4T mark; and in FIG. 17(m) and FIG. 17(o), a 5T mark. FIG. 17(a) and FIG. 17(c) both in which the recording mark is the 2T mark are different on whether the recording mark immediately previous to the shortest 2T space is a 2T mark which is the shortest mark, or a recording mark of another length (4T mark in this example). Therefore, for recording the same recording mark, different recording parameters are set for different patterns in FIG. 17(b) and FIG. 17(d). In FIG. 17(b) and FIG. 17(d), the recording mark is a 2T mark. Regarding recording marks of other lengths, different recording parameters are set for different patterns in a similar manner.

Here, the leading edge of the recording mark is adjusted to an appropriate edge position by the recording parameters of the rise edge position dTps1 of the leading pulse and the fall edge position dtpe1 of the leading pulse. In this case, the pattern table in FIG. 16 includes two tables, i.e., one of dTps1 and the other of dTpe1. In this embodiment, the leading edge of the recording mark is adjusted by the recording parameters of dTps1 and dTpe1. Alternatively, only the position of the rise edge position dTps1 of the leading pulse may be changed.

<Pattern Table 1-2 Regarding the Leading Edge>

Among the cases in FIG. 16, in the case where the immediately previous recording mark is the shortest mark, the recording parameter is set differently in accordance with the length of the space immediately previous to the shortest mark. FIG. 18 shows a pattern table in this case. In FIG. 18, the patterns framed by the thick line is expanded with respect to FIG. 18. The patterns in the expanded part will be described.

In FIG. 18, in the case where the immediately previous recording mark M(i−2) is the shortest mark, the recording parameter is differently in accordance with the length of the space S(i−3) immediately previous to the shortest mark. Setting the recording parameter differently by the length of the immediately previous space S(i−3) is especially performed to deal with the case where a 2T continuous pattern 2m2s located immediately previous to the recording mark M(i) is entirely bit-shifted to cause an error. By adjusting the recording parameter by the length of the space S(i−3) immediately previous to the 2T continuous pattern and the recording mark M(i) immediately subsequent to the 2T continuous pattern, the shift of the 2T continuous pattern, which is the cause of the error, can be decreased. Therefore, in this embodiment, the recording parameter is set by the recording mark M(i).

FIG. 19 shows recording pulses corresponding to different recording parameters regarding the leading edge of a recording mark in the case where the space immediately previous thereto is the shortest space and the recording mark immediately previous to the shortest space is the shortest mark.

FIG. 19(a) shows an NRZI signal of pattern 2s2m2s2Tm, and FIG. 19(b) shows a recording pulse for the NRZI signal of pattern 2s2m2s2Tm;

FIG. 19(c) shows an NRZI signal of pattern 3s2m2s2Tm, and FIG. 19(d) shows a recording pulse for the NRZI signal of pattern 3s2m2s2Tm;

FIG. 19(e) shows an NRZI signal of pattern 2s2m2s3Tm, and FIG. 19(f) shows a recording pulse for the NRZI signal of pattern 2s2m2s3Tm;

FIG. 19(g) shows an NRZI signal of pattern 3s2m2s3Tm, and FIG. 19(h) shows a recording pulse for the NRZI signal of pattern 3s2m2s3Tm;

FIG. 19(i) shows an NRZI signal of pattern 2s2m2s4Tm, and FIG. 19(j) shows a recording pulse for the NRZI signal of pattern 2s2m2s4Tm;

FIG. 19(k) shows an NRZI signal of pattern 3s2m2s4Tm, and FIG. 19(l) shows a recording pulse for the NRZI signal of pattern 3s2m2s4Tm;

FIG. 19(m) shows an NRZI signal of pattern 2s2m2s5Tm, and FIG. 19(n) shows a recording pulse for the NRZI signal of pattern 2s2m2s5Tm; and

FIG. 19(o) shows an NRZI signal of pattern 3s2m2s5Tm, and FIG. 19(p) shows a recording pulse for the NRZI signal of pattern 3s2m2s5Tm.

The recording mark as the target of the recording parameter setting is: in FIG. 19(a) and FIG. 19(c), a 2T mark; in FIG. 19(e) and FIG. 19(g), a 3T mark; in FIG. 19(i) and FIG. 19(k), a 4T mark; and in FIG. 19(m) and FIG. 19(o), a 5T mark. FIG. 19(a) and FIG. 19(c) both in which the recording mark is the 2T mark are different on whether the space immediately previous to the shortest 2T mark is a 2T space which is the shortest space, or a space of another length (3T space in this example). Therefore, for recording the same 2T recording mark, different recording parameters are set for different patterns in FIG. 19(b) and FIG. 19(d). In FIG. 19(b) and FIG. 19(d), the recording mark is a 2T mark. Regarding recording marks of other lengths, different recording parameters are set for different patterns in a similar manner.

<Pattern Table 2-1 Regarding the Leading Edge>

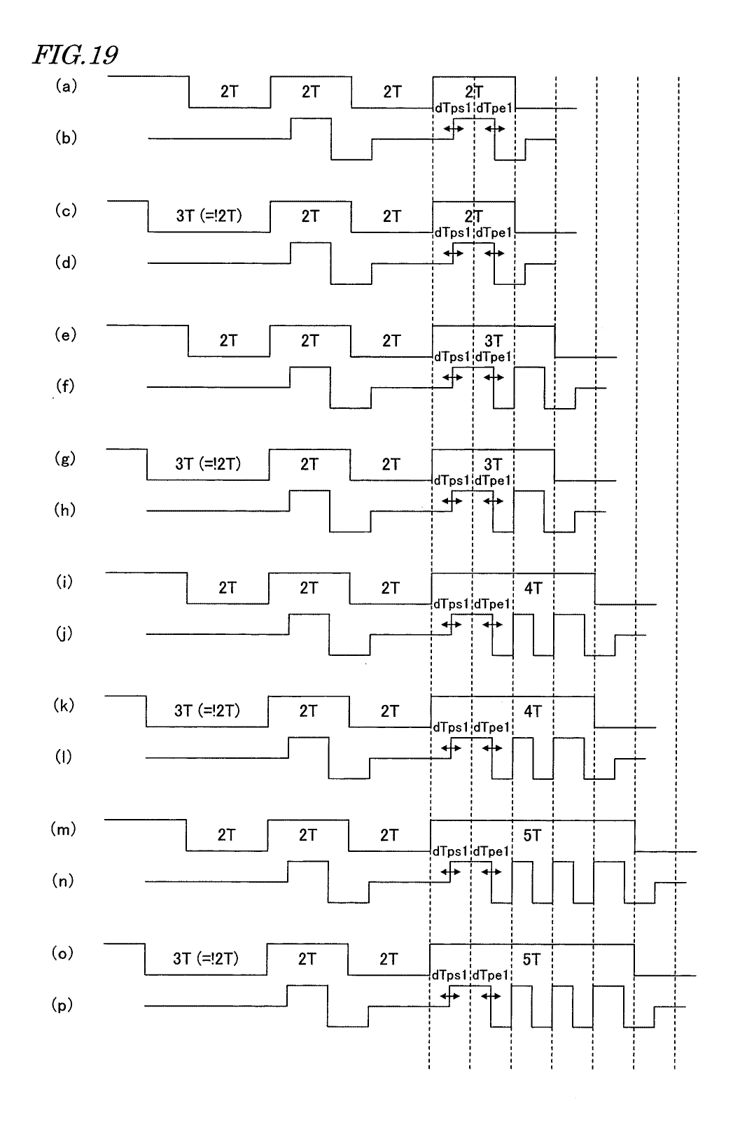

Table 2 of the recording parameter regarding the leading edge of a recording mark is shown in FIG. 20. A feature of Table 2 is that when the recording mark is the shortest mark, the recording parameter is set differently in accordance with the length of the space immediately subsequent to the recording mark. Therefore, the recording mark which is the target of the pattern table is the shortest mark.

It is understood that the pattern table in FIG. 20 is the same as the conventional pattern table in FIG. 5 in the case where the recording mark is a mark other than the shortest mark, i.e., a 3T or longer mark. Only in the case where the recording mark M(i) is the shortest mark, the pattern representation varies in accordance with the length of the immediately subsequent space S(i+1). Namely, in this case, the recording parameter is set differently in accordance with the difference in the length of the space immediately subsequent to the shortest mark.

As described above, in high density recording, the shortest mark is shorter than the other recording marks. Therefore, even when the immediately previous space is long, if the immediately subsequent space is short, the heat amount at the time of forming a recording mark immediately subsequent to the short space is conveyed. This generally influences the trailing edge of the recording mark, but in high density recording, this also influences the leading edge as well as the trailing edge because the recording mark is extremely short. Therefore, in this embodiment, the recording parameter is set differently in accordance with the difference in the length of the space immediately subsequent to the shortest mark, so that a more appropriate recording mark can be formed in high density recording.

In this embodiment, the length of the immediately subsequent space is classified as the shortest space 2Ts which is most liable to be influenced by the thermal interference or spaces of other lengths !2Ts. This is performed in consideration of the scale of the circuit having the recording parameter. In the case where the circuit scale can be ignored, it is desirable that a space of 3T space or longer can be set differently.

Especially in the case where the immediately previous space S(i−1) is a 3T space or longer, when the immediately subsequent space is the shortest space 2Ts, the recording condition regarding the 12B patterns described above (more strictly, 2T continuous patterns including the 12B patterns) is applied. When the immediately subsequent space is other than the shortest space, i.e., !2Ts, the recording condition regarding the 12A patterns described above is applied. In this manner, the recording adjustment can be made with the 12A patterns and the 12B patterns being separated.

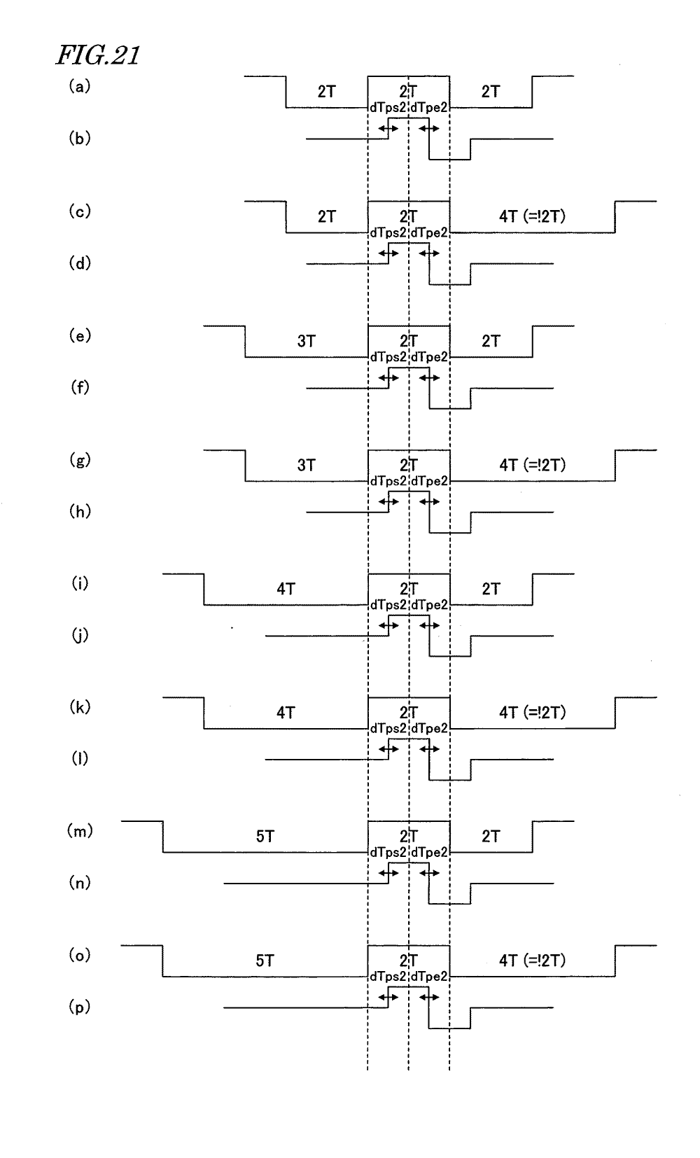

FIG. 21 shows recording pulses corresponding to different recording parameters regarding the leading edge of a shortest mark sandwiched between the space immediately previous thereto and the space immediately subsequent thereto.

FIG. 21(a) shows an NRZI signal of pattern 2s2Tm2s, and FIG. 21(b) shows a recording pulse for the NRZI signal of pattern 2s2Tm2s;

FIG. 21(c) shows an NRZI signal of pattern 2s2Tm4s, and FIG. 21(d) shows a recording pulse for the NRZI signal of pattern 2s2Tm4s;

FIG. 21(e) shows an NRZI signal of pattern 3s2Tm2s, and FIG. 21(f) shows a recording pulse for the NRZI signal of pattern 3s2Tm2s;

FIG. 21(g) shows an NRZI signal of pattern 3s2Tm4s, and FIG. 21(h) shows a recording pulse for the NRZI signal of pattern 3s2Tm4s;

FIG. 21(i) shows an NRZI signal of pattern 4s2Tm2s, and FIG. 21(j) shows a recording pulse for the NRZI signal of pattern 4s2Tm2s;

FIG. 21(k) shows an NRZI signal of pattern 4s2Tm4s, and FIG. 21(l) shows a recording pulse for the NRZI signal of pattern 4s2Tm4s;

FIG. 21(m) shows an NRZI signal of pattern 5s2Tm2s, and FIG. 21(n) shows a recording pulse for the NRZI signal of pattern 5s2Tm2s; and

FIG. 21(o) shows an NRZI signal of pattern 5s2Tm4s, and FIG. 21(p) shows a recording pulse for the NRZI signal of pattern 5s2Tm4s.

The space immediately previous to the recording mark as the target of the recording parameter setting is: in FIG. 21(a) and FIG. 21(c), a 2T space; in FIG. 21(e) and FIG. 21(g), a 3T space; in FIG. 21(i) and FIG. 21(k), a 4T space; and in FIG. 21(m) and FIG. 21(o), a 5T space. FIG. 21(a) and FIG. 21(c) both in which the immediately previous space is the 2T space are different on whether the immediately subsequent space is a 2T space which is the shortest space, or a space of another length (4T space in this example). Therefore, for recording the same 2T mark, different recording parameters are set for different patterns in FIG. 21(b) and FIG. 21(d). In FIG. 21(b) and FIG. 21(d), the immediately previous space is a 2T space. Regarding immediately previous spaces of other lengths, different recording parameters are set for different patterns in a similar manner.

Here, the leading edge of the recording mark is adjusted to an appropriate edge position by the recording parameters of the rise edge position dTps2 of the leading pulse and the fall edge position dTpe2 of the leading pulse. In this case, the pattern table in FIG. 20 includes two tables, i.e., one of dTps2 and the other of dTpe2. In this embodiment, the leading edge of the recording mark is adjusted by the recording parameters of dTps2 and dTpe2. Alternatively, only the position of the rise edge position dTps2 of the leading pulse may be changed.

<Pattern Table 2-2 Regarding the Leading Edge>

Among the cases in FIG. 20, in the case where the immediately subsequent space is the shortest space, the recording parameter is set differently in accordance with the length of the recording mark immediately subsequent to the shortest space. FIG. 22 shows a pattern table in this case. In FIG. 22, the patterns framed by the thick line is expanded with respect to FIG. 20. The patterns in the expanded part will be described.

In FIG. 22, in the case where the immediately subsequent space S(i+1) is the shortest space, the recording parameter is set differently in accordance with the length of the recording mark M(i+2) immediately subsequent to the shortest space. Setting the recording parameter differently by the length of the immediately subsequent recording mark M(i+2) is especially performed to deal with the case where a 2T continuous pattern 2m2s of the recording mark M(i) and the space immediately subsequent thereto is entirely bit-shifted to cause an error. By adjusting the recording parameter by the length of the space S(i−1) immediately previous to the 2T continuous pattern and the recording mark M(i+2) immediately subsequent to the 2T continuous pattern, the shift of the 2T continuous pattern, which is the cause of the error, can be decreased. Therefore, in this embodiment, the recording parameter is set by the recording mark M(i).

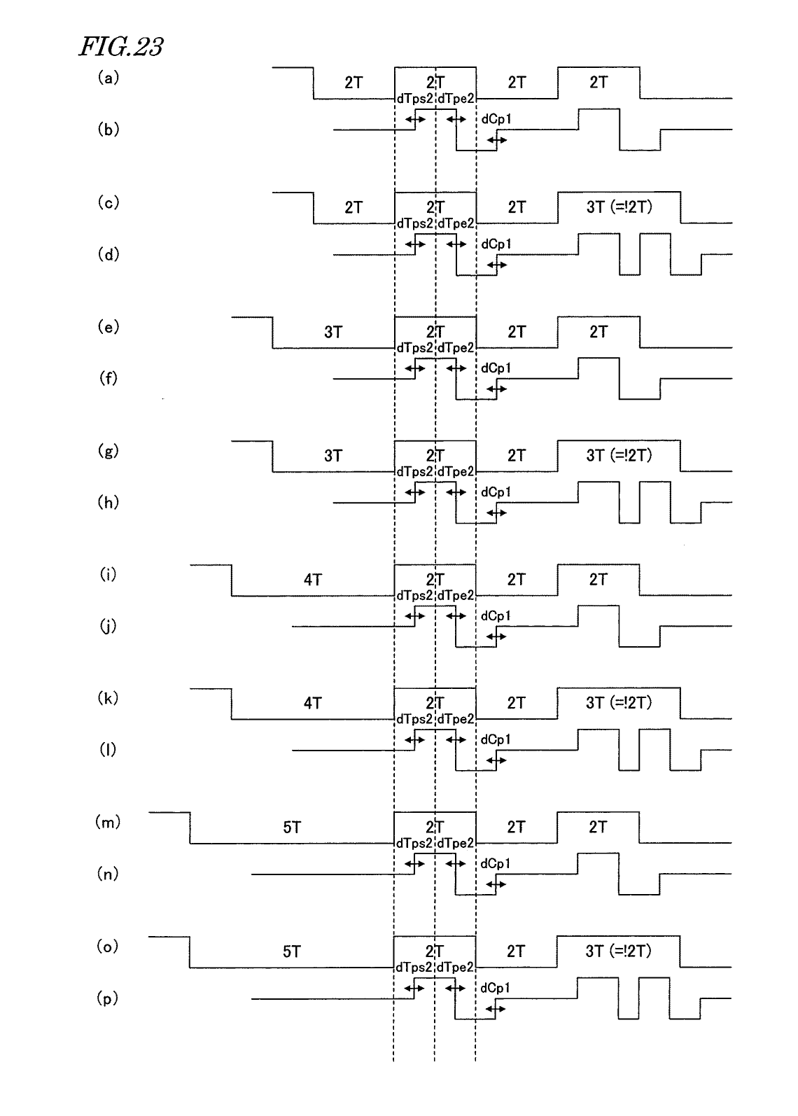

FIG. 23 shows recording pulses corresponding to different recording parameters regarding the leading edge of a shortest mark sandwiched between the space immediately previous thereto and the shortest space immediately subsequent thereto.

FIG. 23(a) shows an NRZI signal of pattern 2s2Tm2s2m, and FIG. 23(b) shows a recording pulse for the NRZI signal of pattern 2s2Tm2s2m;

FIG. 23(c) shows an NRZI signal of pattern 2s2Tm2s3m, and FIG. 23(d) shows a recording pulse for the NRZI signal of pattern 2s2Tm2s3m;

FIG. 23(e) shows an NRZI signal of pattern 3s2Tm2s2m, and FIG. 23(f) shows a recording pulse for the NRZI signal of pattern 3s2Tm2s2m;

FIG. 23(g) shows an NRZI signal of pattern 3s2Tm2s3m, and FIG. 23(h) shows a recording pulse for the NRZI signal of pattern 3s2Tm2s3m;

FIG. 23(i) shows an NRZI signal of pattern 4s2Tm2s2m, and FIG. 23(j) shows a recording pulse for the NRZI signal of pattern 4s2Tm2s2m;

FIG. 23(k) shows an NRZI signal of pattern 4s2Tm2s3m, and FIG. 23(l) shows a recording pulse for the NRZI signal of pattern 4s2Tm2s3m;

FIG. 23(m) shows an NRZI signal of pattern 5s2Tm2s2m, and FIG. 23(n) shows a recording pulse for the NRZI signal of pattern 5s2Tm2s2m; and

FIG. 23(o) shows an NRZI signal of pattern 5s2Tm2s3m, and FIG. 23(p) shows a recording pulse for the NRZI signal of pattern 5s2Tm2s3m.

The space immediately previous to the recording mark as the target of the recording parameter setting is: in FIG. 23(a) and FIG. 23(c), a 2T space; in FIG. 23(e) and FIG. 23(g), a 3T space; in FIG. 23(i) and FIG. 23(k), a 4T space; and in FIG. 23(m) and FIG. 23(o), a 5T space. FIG. 23(a) and FIG. 23(c) both in which the immediately previous space is the 2T space are different on whether the length of the shortest recording mark subsequent to the 2T space is a 2T mark which is the shortest mark, or a mark of another length (3T mark in this example).

Therefore, for recording the same 2T mark, different recording parameters are set for different patterns in FIG. 23(b) and FIG. 23(d). In FIG. 23(b) and FIG. 23(d), the immediately previous space is a 2T space. Regarding immediately previous spaces of other lengths, different recording parameters are set for different patterns in a similar manner.

<Pattern Table 1-1 Regarding the Trailing edge>

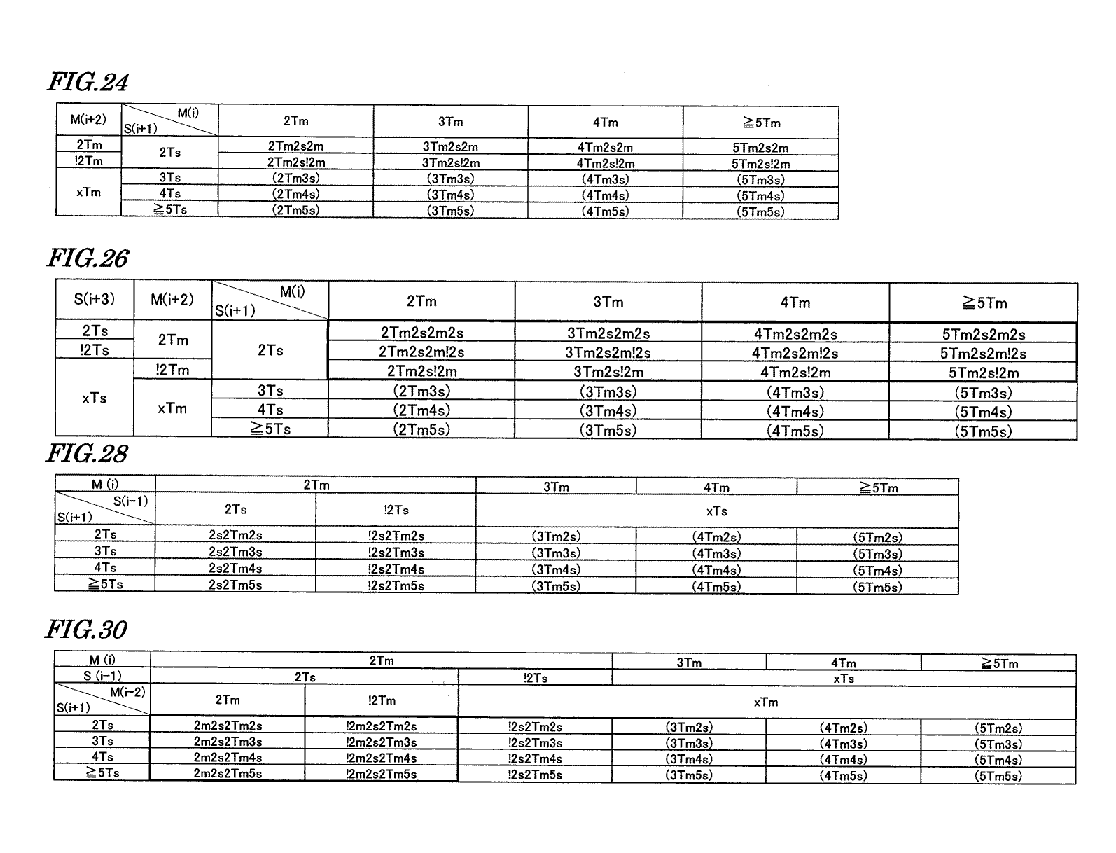

Table 1 of the recording parameter regarding the trailing edge of a recording mark is shown in FIG. 24. A feature of Table 1 is that when the immediately subsequent space is the shortest space, the recording parameter is set differently in accordance with the length of the space immediately subsequent to the shortest space. All the recording marks are the target of the pattern table.

It is understood that the pattern table in FIG. 24 is the same as the conventional pattern table in FIG. 5 in the case where the immediately subsequent space is a space other than the shortest space, i.e., a 3T or longer space. Only in the case where the immediately subsequent space S(i+1) is the shortest space, the pattern representation varies in accordance with the length of the mark M(i+2) immediately subsequent to the shortest space. Namely, in this case, the recording parameter is set differently in accordance with the difference in the length of the mark immediately subsequent to the shortest space. The reason is that in the influence of the thermal influence is largest when the immediately subsequent space is the shortest space, as when the immediately previous space is the shortest space.

Especially in the case where the recording mark M(i) is a 3T mark or longer, when the immediately subsequent recording mark is the shortest mark 2Tm, the recording condition regarding the 12B patterns described above (more strictly, 2T continuous patterns including the 12B patterns) is applied. When the immediately subsequent recording mark is other than the shortest mark, i.e., !2Tm, the recording condition regarding the 12A patterns described above is applied. In this manner, the recording adjustment can be made with the 12A patterns and the 12B patterns being separated.

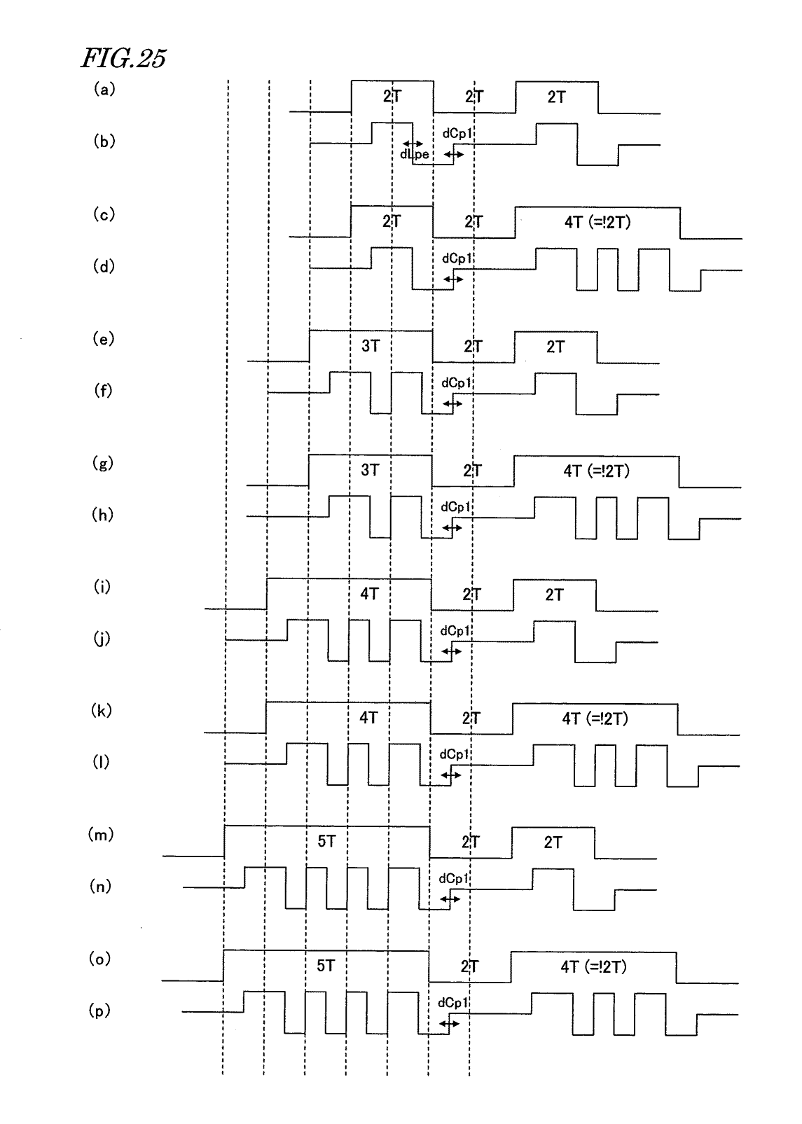

FIG. 25 shows recording pulses corresponding to different recording parameters regarding the trailing edge of a recording mark in the case where the immediately subsequent space is the shortest space.

FIG. 25(a) shows an NRZI signal of pattern 2Tm2s2m, and FIG. 25(b) shows a recording pulse for the NRZI signal of pattern 2Tm2s2m;

FIG. 25(c) shows an NRZI signal of pattern 2Tm2s4m, and FIG. 25(d) shows a recording pulse for the NRZI signal of pattern 2Tm2s4m;

FIG. 25(e) shows an NRZI signal of pattern 3Tm2s2m, and FIG. 25(f) shows a recording pulse for the NRZI signal of pattern 3Tm2s2m;

FIG. 25(g) shows an NRZI signal of pattern 3Tm2s4m, and FIG. 25(h) shows a recording pulse for the NRZI signal of pattern 3Tm2s4m;

FIG. 25(i) shows an NRZI signal of pattern 4Tm2s2m, and FIG. 25(j) shows a recording pulse for the NRZI signal of pattern 4Tm2s2m;

FIG. 25(k) shows an NRZI signal of pattern 4Tm2s4m, and FIG. 25(l) shows a recording pulse for the NRZI signal of pattern 4Tm2s4m;

FIG. 25(m) shows an NRZI signal of pattern 5Tm2s2m, and FIG. 25(n) shows a recording pulse for the NRZI signal of pattern 5Tm2s2m; and

FIG. 25(o) shows an NRZI signal of pattern 5Tm2s4m, and FIG. 25(p) shows a recording pulse for the NRZI signal of pattern 5Tm2s4m.

The recording mark as the target of the recording parameter setting is: in FIG. 25(a) and FIG. 25(c), a 2T mark; in FIG. 25(e) and FIG. 25(g), a 3T mark; in FIG. 25(i) and FIG. 25(k), a 4T mark; and in FIG. 25(m) and FIG. 25(o), a 5T mark. FIG. 25(a) and FIG. 25(c) both in which the recording mark is the 2T mark are different on whether the recording mark immediately subsequent to the shortest 2T space is a 2T mark which is the shortest mark, or a mark of another length (4T mark in this example). Therefore, for recording the same 2T mark, different recording parameters are set for different patterns in FIG. 25(b) and FIG. 25(d). In FIG. 25(b) and FIG. 25(d), the recording mark is a 2T mark. Regarding recording marks of other lengths, different recording parameters are set for different patterns in a similar manner.

Here, the trailing edge of the recording mark is adjusted to an appropriate edge position by the recording parameter of the recording end position offset dCp1. In this case, the pattern table in FIG. 24 includes the table of dCp1. In this embodiment, the trailing edge of the recording mark is adjusted by the recording parameter of dCp1. Alternatively, only the fall edge position dLpe of the last pulse (only shown in FIG. 25(b)) may be changed. It is noted that for a 2T mark, which is a mono-pulse, dLpe is in a competitive relationship against dTpe1 or dTpe2 in terms of the pulse setting conditions. Therefore, the fall edge position dLpe of the pulse is usable only when neither dTpe1 nor dTpe2 is used in mono-pulse recording.

<Pattern Table 1-2 Regarding the Trailing Edge>

Among the cases in FIG. 24, in the case where the immediately subsequent recording mark is the shortest mark, the recording parameter is set differently in accordance with the length of the space immediately subsequent to the shortest mark. FIG. 26 shows a pattern table in this case. In FIG. 26, the patterns framed by the thick line is expanded with respect to FIG. 24. The patterns in the expanded part will be described.

In FIG. 26, in the case where the immediately subsequent recording mark M(i+2) is the shortest mark, the recording parameter is set differently in accordance with the length of the space S(i+3) immediately subsequent to the shortest mark. Setting the recording parameter differently by the length of the immediately subsequent space S(i+3) is especially performed to deal with the case where a 2T continuous pattern 2m2s located immediately previous to the recording mark M(i) is entirely bit-shifted to cause an error. By adjusting the recording parameter by the length of the space S(i+3) immediately subsequent to the 2T continuous pattern and the recording mark M(i) immediately subsequent to the 2T continuous pattern, the shift of the 2T continuous pattern, which is the cause of the error, can be decreased. Therefore, in this embodiment, the recording parameter is set by the recording mark M(i).

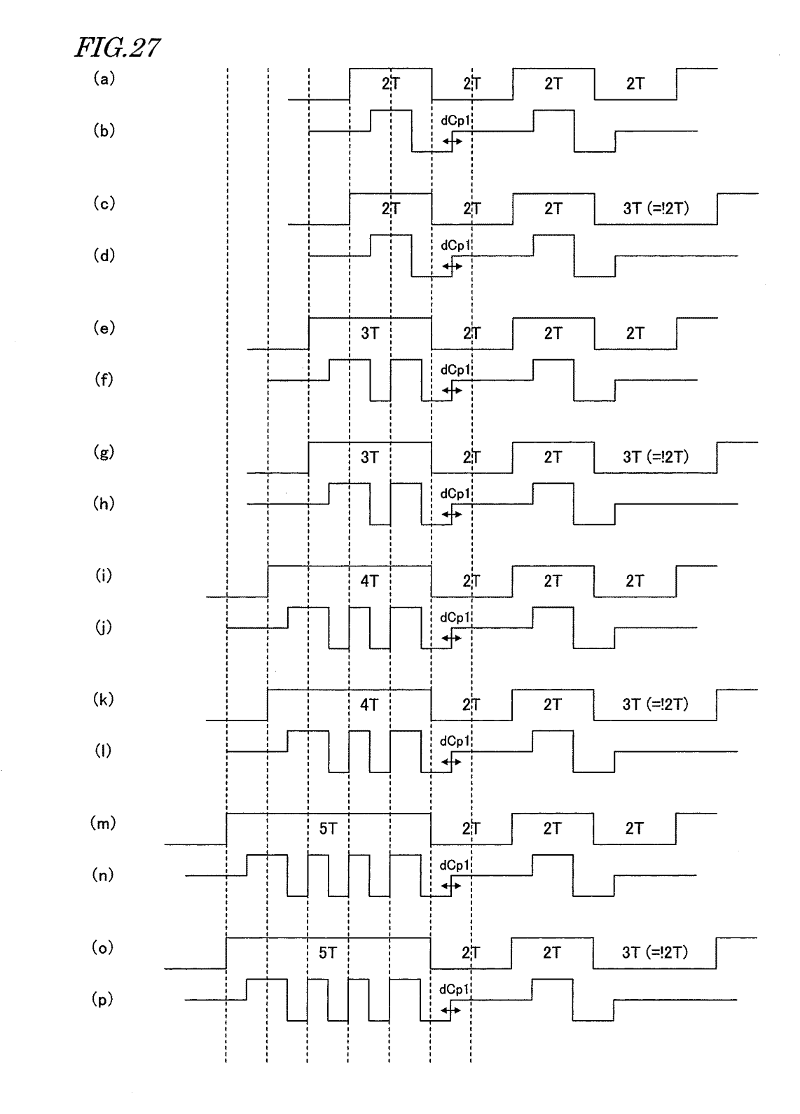

FIG. 27 shows recording pulses corresponding to different recording parameters regarding the trailing edge of a recording mark in the case where the space immediately subsequent thereto is the shortest space and the recording mark immediately subsequent to the shortest space is the shortest mark.

FIG. 27(a) shows an NRZI signal of pattern 2Tm2s2m2s, and FIG. 27(b) shows a recording pulse for the NRZI signal of pattern 2Tm2s2m2s;

FIG. 27(c) shows an NRZI signal of pattern 2Tm2s2m3s, and FIG. 27(d) shows a recording pulse for the NRZI signal of pattern 2Tm2s2m3s;

FIG. 27(e) shows an NRZI signal of pattern 3Tm2s2m2s, and FIG. 27(f) shows a recording pulse for the NRZI signal of pattern 3Tm2s2m2s;

FIG. 27(g) shows an NRZI signal of pattern 3Tm2s2m3s, and FIG. 27(h) shows a recording pulse for the NRZI signal of pattern 3Tm2s2m3s;

FIG. 27(i) shows an NRZI signal of pattern 4Tm2s2m2s, and FIG. 27(j) shows a recording pulse for the NRZI signal of pattern 4Tm2s2m2s;

FIG. 27(k) shows an NRZI signal of pattern 4Tm2s2m3s, and FIG. 27(l) shows a recording pulse for the NRZI signal of pattern 4Tm2s2m3s;

FIG. 27(m) shows an NRZI signal of pattern 5Tm2s2m2s, and FIG. 27(n) shows a recording pulse for the NRZI signal of pattern 5Tm2s2m2s; and

FIG. 27(o) shows an NRZI signal of pattern 5Tm2s2m3s, and FIG. 27(p) shows a recording pulse for the NRZI signal of pattern 5Tm2s2m3s.

The recording mark as the target of the recording parameter setting is: in FIG. 27(a) and FIG. 27(c), a 2T mark; in FIG. 27(e) and FIG. 27(g), a 3T mark; in FIG. 27(i) and FIG. 27(k), a 4T mark; and in FIG. 27(m) and FIG. 27(o), a 5T mark. FIG. 27(a) and FIG. 27(c) both in which the recording mark is the 2T mark are different on whether the space immediately subsequent to the shortest 2T mark is a 2T space which is the shortest space, or a space of another length (3T space in this example). Therefore, for recording the same 2T recording mark, different recording parameters are set for different patterns in FIG. 27(b) and FIG. 27(d). In FIG. 27(b) and FIG. 27(d), the recording mark is a 2T mark. Regarding recording marks of other lengths, different recording parameters are set for different patterns in a similar manner.

<Pattern Table 2-1 Regarding the Trailing Edge>

Table 2 of the recording parameter regarding the trailing edge of a recording mark is shown in FIG. 28. A feature of Table 2 is that when the recording mark is the shortest mark, the recording parameter is set differently in accordance with the length of the space immediately previous to the recording mark. Therefore, the recording mark which is the target of the pattern table is the shortest mark.

It is understood that the pattern table in FIG. 28 is the same as the conventional pattern table in FIG. 5 in the case where the recording mark is a mark other than the shortest mark, i.e., a 3T or longer mark. Only in the case where the recording mark M(i) is the shortest mark, the pattern representation varies in accordance with the length of the immediately previous space S(i−1). Namely, in this case, the recording parameter is set differently in accordance with the difference in the length of the space immediately previous to the shortest mark.

As described above, in high density recording, the shortest mark is shorter than the other recording marks. Therefore, even when the immediately subsequent space is long, if the immediately previous space is short, the heat amount at the time of forming a recording mark immediately previous to the short space is conveyed. This generally influences the leading edge of the recording mark, but in high density recording, this also influences the trailing edge as well as the leading edge because the recording mark is extremely short. Therefore, in this embodiment, the recording parameter is set differently in accordance with the difference in the length of the space immediately previous to the shortest mark, so that a more appropriate recording mark can be formed in high density recording.

In this embodiment, the length of the immediately previous space is classified as the shortest space 2Ts which is most liable to be influenced by the thermal interference or spaces of other lengths !2Ts. This is performed in consideration of the scale of the circuit having the recording parameter. In the case where the circuit scale can be ignored, it is desirable that a space of 3T space or longer can be set differently.

Especially in the case where the immediately subsequent space S(i+1) is a 3T space or longer, when the immediately previous space is the shortest space 2Ts, the recording condition regarding the 12B patterns described above (more strictly, 2T continuous patterns including the 12B patterns) is applied. When the immediately previous space is other than the shortest space, i.e., !2Ts, the recording condition regarding the 12A patterns described above is applied. Accordingly, the recording adjustment can be made with the 12A patterns and the 12B patterns being separated.

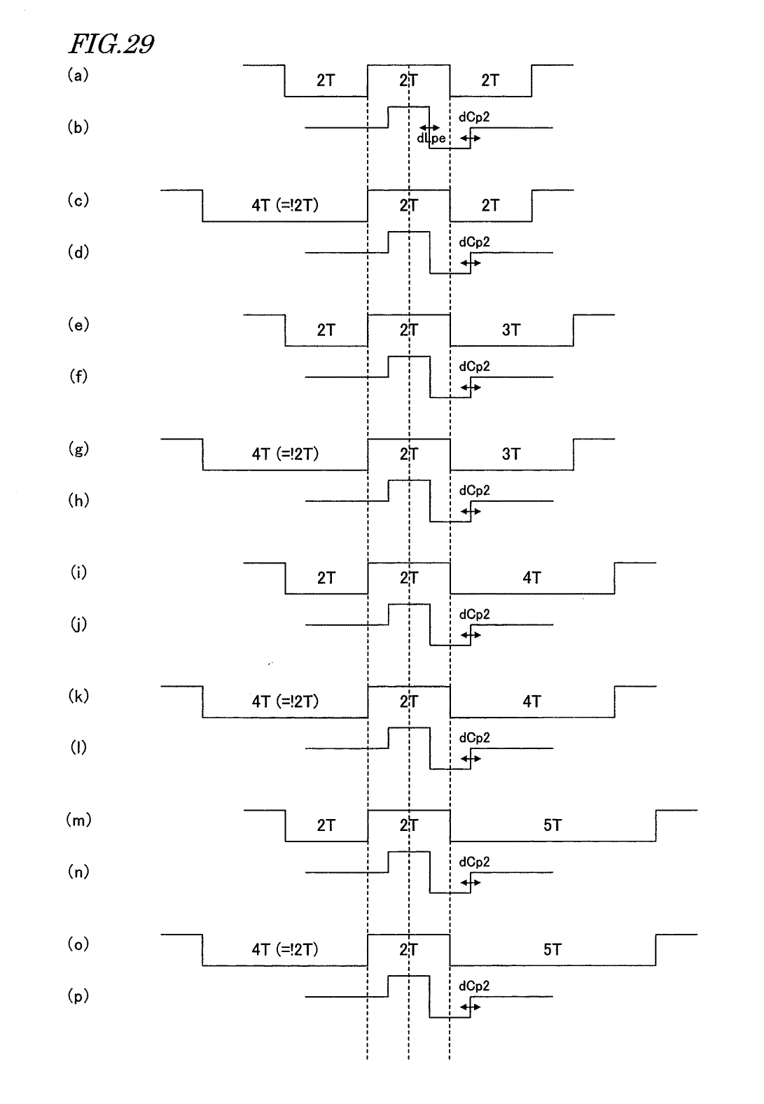

FIG. 29 shows recording pulses corresponding to different recording parameters regarding the trailing edge of a shortest mark sandwiched between the space immediately previous thereto and the space immediately subsequent thereto.

FIG. 29(a) shows an NRZI signal of pattern 2s2Tm2s, and FIG. 29(b) shows a recording pulse for the NRZI signal of pattern 2s2Tm2s;

FIG. 29(c) shows an NRZI signal of pattern 4s2Tm2s, and FIG. 29(d) shows a recording pulse for the NRZI signal of pattern 4s2Tm2s;

FIG. 29(e) shows an NRZI signal of pattern 2s2Tm3s, and FIG. 29(f) shows a recording pulse for the NRZI signal of pattern 2s2Tm3s;

FIG. 29(g) shows an NRZI signal of pattern 4s2Tm3s, and FIG. 29(h) shows a recording pulse for the NRZI signal of pattern 4s2Tm3s;

FIG. 29(i) shows an NRZI signal of pattern 2s2Tm4s, and FIG. 29(j) shows a recording pulse for the NRZI signal of pattern 2s2Tm4s;

FIG. 29(k) shows an NRZI signal of pattern 4s2Tm4s, and FIG. 29(l) shows a recording pulse for the NRZI signal of pattern 4s2Tm4s;

FIG. 29(m) shows an NRZI signal of pattern 2s2Tm5s, and FIG. 29(n) shows a recording pulse for the NRZI signal of pattern 2s2Tm5s; and

FIG. 29(o) shows an NRZI signal of pattern 4s2Tm5s, and FIG. 29(p) shows a recording pulse for the NRZI signal of pattern 4s2Tm5s.

The space immediately subsequent to the recording mark as the target of the recording parameter setting is: in FIG. 29(a) and FIG. 29(c), a 2T space; in FIG. 29(e) and FIG. 29(g), a 3T space; in FIG. 29(i) and FIG. 29(k), a 4T space; and in FIG. 29(m) and FIG. 29(o), a 5T space. FIG. 29(a) and FIG. 29(c) both in which the immediately subsequent space is the 2T space are different on whether the immediately previous space is a 2T space which is the shortest space, or a space of another length (4T space in this example). Therefore, for recording the same 2T mark, different recording parameters are set for different patterns in FIG. 29(b) and FIG. 29(d). In FIG. 29(b) and FIG. 29(d), the immediately subsequent space is a 2T space. Regarding immediately previous spaces of other lengths, different recording parameters are set for different patterns in a similar manner.

Here, the trailing edge of the recording mark is adjusted to an appropriate edge position by the recording parameter of the recording end position offset dCp2. In this case, the pattern table in FIG. 28 includes the table of dCp2. In this embodiment, the trailing edge of the recording mark is adjusted by the recording parameter of dCp2. Alternatively, only the fall edge position dLpe of the last pulse (only shown in FIG. 29(b)) may be changed. It is noted that for a 2T mark, which is a mono-pulse, dlpe is in a competitive relationship against dtpe1 or dTpe2 in terms of the pulse setting conditions. Therefore, the fall edge position dLpe of the pulse is usable only when neither dTpe1 nor dTpe2 is used in mono-pulse recording.

<Pattern Table 2-2 Regarding the Trailing edge>

Among the cases in FIG. 28, in the case where the immediately previous space is the shortest space, the recording parameter is set differently in accordance with the length of the recording mark immediately previous to the shortest space. FIG. 30 shows a pattern table in this case. In FIG. 30, the patterns framed by the thick line is expanded with respect to FIG. 28. The patterns in the expanded part will be described.

In FIG. 30, in the case where the immediately previous space S(i−1) is the shortest space, the recording parameter is set differently in accordance with the length of the recording mark M(i−2) immediately previous to the shortest space. Setting the recording parameter differently by the length of the immediately previous recording mark M(i−2) is especially performed to deal with the case where a 2T continuous pattern 2m2s of the recording mark M(i) and the space immediately previous thereto is entirely bit-shifted to cause an error. By adjusting the recording parameter by the length of the space S(i+1) immediately subsequent to the 2T continuous pattern and the recording mark M(i−2) immediately previous to the 2T continuous pattern, the shift of the 2T continuous pattern, which is the cause of the error, can be decreased. Therefore, in this embodiment, the recording parameter is set by the recording mark M(i).

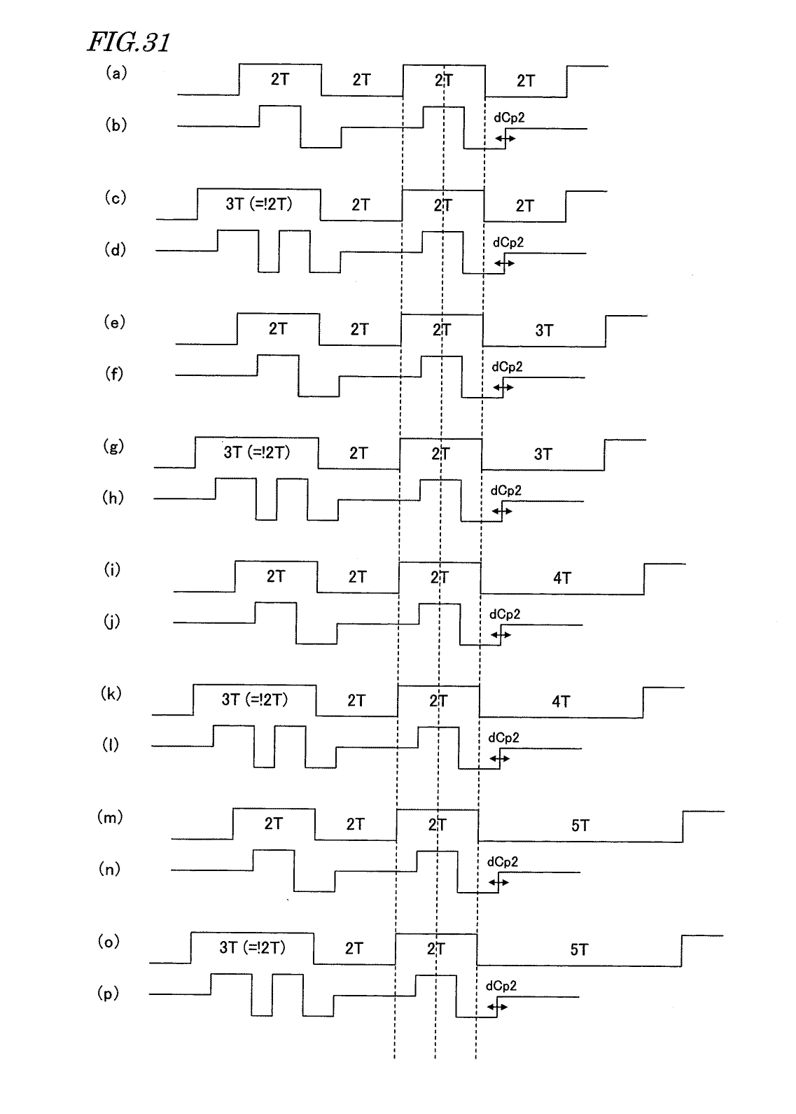

FIG. 31 shows recording pulses corresponding to different recording parameters regarding the trailing edge of a shortest mark sandwiched between the space immediately subsequent thereto and the space immediately previous to the shortest space.

FIG. 31(a) shows an NRZI signal of pattern 2m2s2Tm2s, and FIG. 31(b) shows a recording pulse for the NRZI signal of pattern 2m2s2Tm2s;

FIG. 31(c) shows an NRZI signal of pattern 3m2s2Tm2s, and FIG. 31(d) shows a recording pulse for the NRZI signal of pattern 3m2s2Tm2s;

FIG. 31(e) shows an NRZI signal of pattern 2m2s2Tm3s, and FIG. 31(f) shows a recording pulse for the NRZI signal of pattern 2m2s2Tm3s;

FIG. 31(g) shows an NRZI signal of pattern 3m2s2Tm3s, and FIG. 31(h) shows a recording pulse for the NRZI signal of pattern 3m2s2Tm3s;

FIG. 31(i) shows an NRZI signal of pattern 2m2s2Tm4s, and FIG. 31(j) shows a recording pulse for the NRZI signal of pattern 2m2s2Tm4s;

FIG. 31(k) shows an NRZI signal of pattern 3m2s2Tm4s, and FIG. 31(l) shows a recording pulse for the NRZI signal of pattern 3m2s2Tm4s;

FIG. 31(m) shows an NRZI signal of pattern 2m2s2Tm5s, and FIG. 31(n) shows a recording pulse for the NRZI signal of pattern 2m2s2Tm5s; and

FIG. 31(o) shows an NRZI signal of pattern 3m2s2Tm5s, and FIG. 31(p) shows a recording pulse for the NRZI signal of pattern 3m2s2Tm5s.

The space immediately subsequent to the recording mark as the target of the recording parameter setting is: in FIG. 31(a) and FIG. 31 (c), a 2T space; in FIG. 31(e) and FIG. 31(g), a 3T space; in FIG. 31(i) and FIG. 31(k), a 4T space; and in FIG. 31(m) and FIG. 31(o), a 5T space. FIG. 31(a) and FIG. 31(c) both in which the immediately subsequent space is the 2T space are different on whether the length of the shortest recording mark previous to the 2T space is a 2T mark which is the shortest mark, or a mark of another length (3T mark in this example).

Therefore, for recording the same 2T mark, different recording parameters are set for different patterns in FIG. 31(b) and FIG. 31(d). In FIG. 31(b) and FIG. 31(d), the immediately subsequent space is a 2T space. Regarding immediately subsequent spaces of other lengths, different recording parameters are set for different patterns in a similar manner.

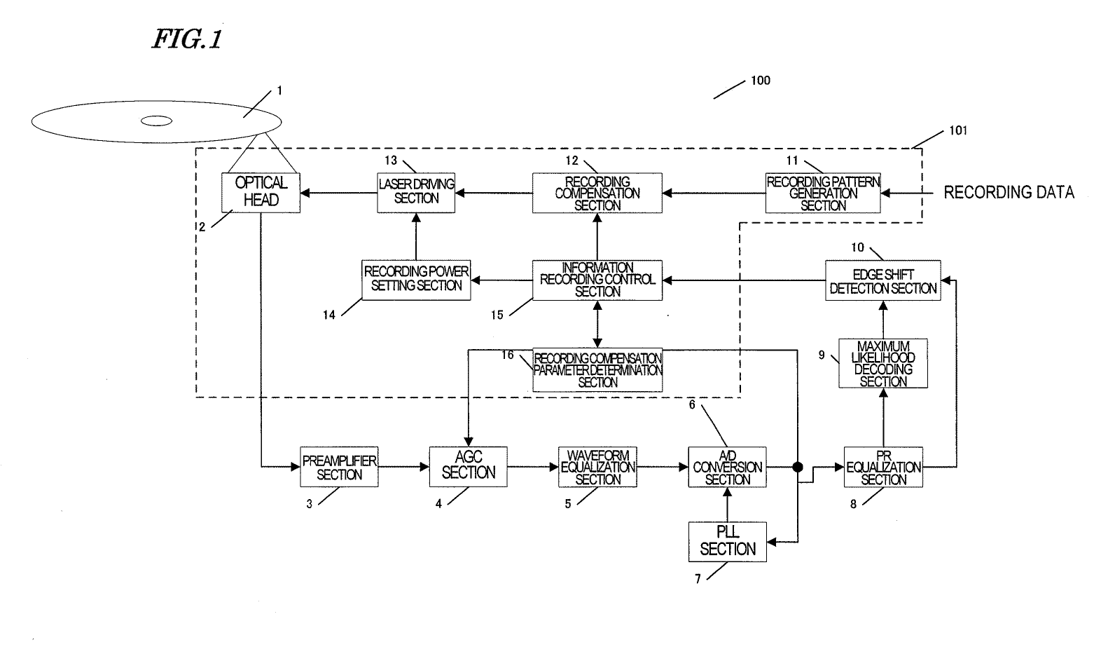

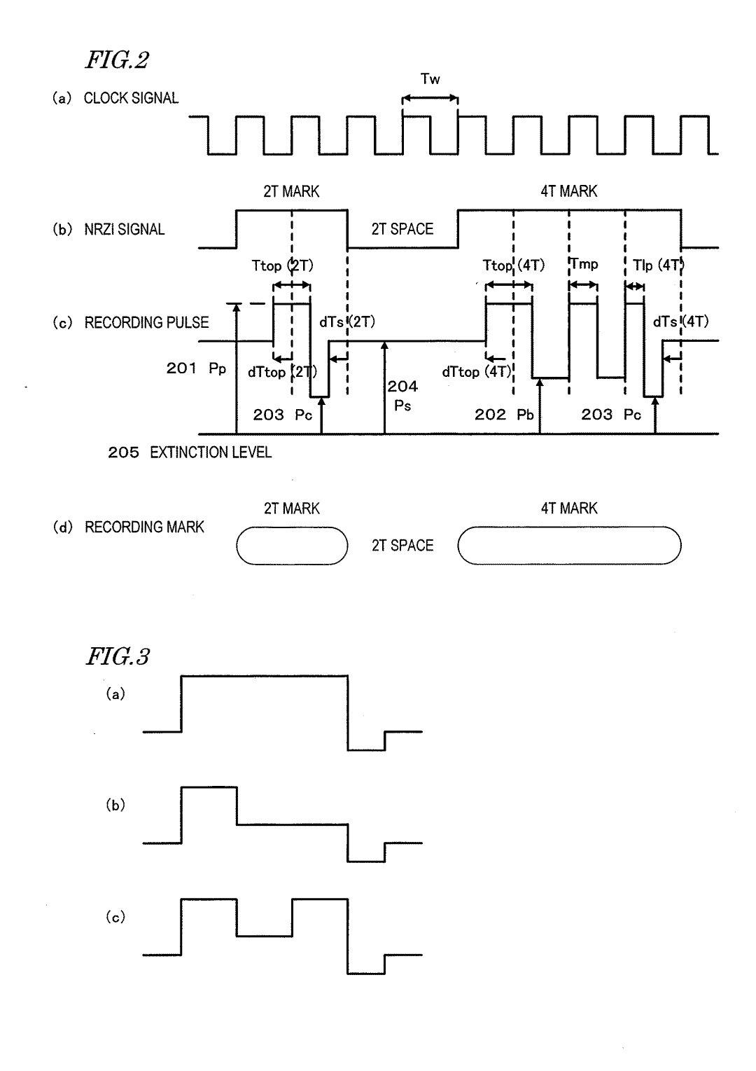

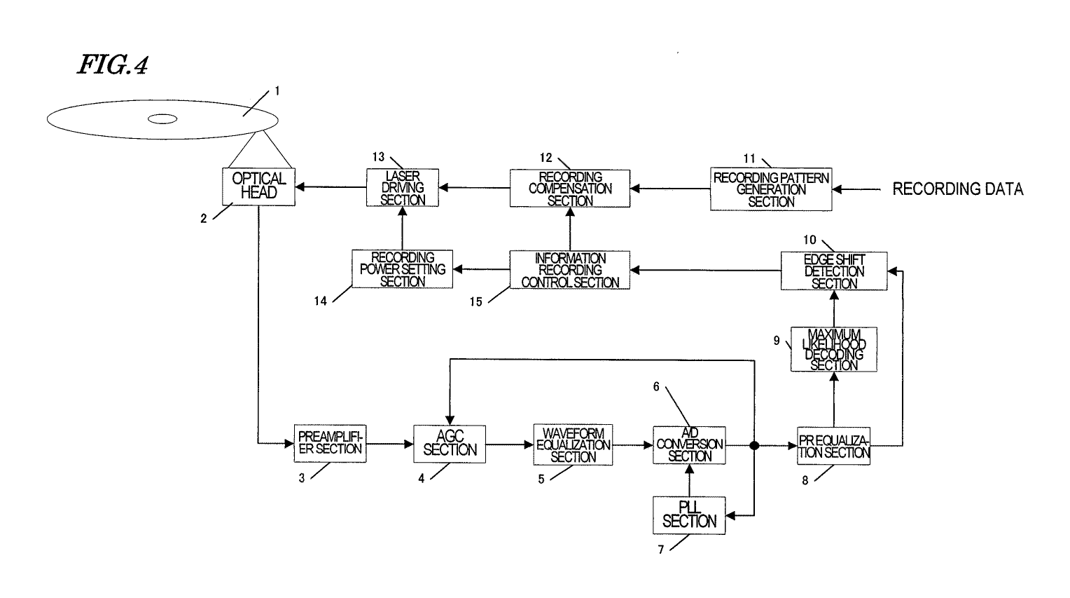

Now, FIG. 1 shows an information recording and reproduction apparatus 100 according to an embodiment of the present invention.

The information recording and reproduction apparatus 100 includes a recording control section 101 and a reproduction signal processing section 102.

The recording control section 101 includes an optical head 2, a recording pattern generation section 11, a recording compensation section 12, a laser driving section 13, a recording power setting section 14, an information recording control section 15, and a recording compensation parameter determination section 16.

The reproduction signal processing section 102 includes a preamplifier section 3, an AGC section 4, a waveform equalization section 5, an A/D conversion section 6, a PLL section 7, a PR equalization section 8, a maximum likelihood decoding section 9, and edge shift detection section 10.

An information recording medium 1 is mounted on the information recording and reproduction apparatus 100. The information recording medium 1 is used for optical information recording or reproduction, and is, for example, an optical disc.

The optical head 2 converges laser light passed through an objective lens to a recording layer of the information recording medium 1 and receives the reflected light to generate an analog reproduction signal which indicates information recorded on the information recording medium 1. The numerical aperture of the objective lens is 0.7 to 0.9, and preferably 0.85.

The wavelength of the laser light is 410 nm or shorter, and preferably 405 nm.

The preamplifier section 3 amplifiers the analog reproduction signal at a prescribed gain and outputs the resultant signal to the AGC section 4.

The AGC section 4 amplifies the reproduction signal using a preset target gain such that the reproduction signal output from the A/D conversion section 6 has a constant level, and outputs the resultant signal to the waveform equalization section 5.

The waveform equalization section 5 has an LPF characteristic for blocking a high frequency range of the reproduction signal and a filtering characteristic for amplifying a prescribed frequency range of the reproduction signal. The waveform equalization section 5 shapes the waveform of the reproduction signal to a desired characteristic and outputs the resultant signal to the A/D conversion section 6.

The PLL section 7 generates a reproduction clock synchronized with the waveform-equalized reproduction signal and outputs the reproduction clock to the A/D conversion section 6.

The A/D conversion section 6 samples the reproduction signal in synchronization with the reproduction clock output from the PLL section 7, converts the analog reproduction signal into a digital reproduction signal, and outputs the digital reproduction signal to the PR equalization section 8, the PLL section 7 and the AGC section 4.

The PR equalization section 8 has a frequency characteristic which is set such that the frequency characteristic of the reproduction system is the characteristic assumed by the maximum likelihood decoding section 9 (for example, the PR(1,2,2,2,1) equalization characteristic). The PR equalization section 8 executes PR equalization processing on the reproduction signal so as to suppress high range noise thereof, and intentionally add inter-code interference thereto, and outputs the resultant reproduction signal to the maximum likelihood decoding section 9.

The PR equalization section 8 may include an FIR (Finite Impulse Response) filtering structure, and may adaptively control the tap coefficient using the LMS (The Least-Mean Square) algorithm (see, “Tekio Shingo Shori Algorithm (Adaptable Signal processing Algorithm) published by Kabushiki Kaisha Baifukan).

The maximum likelihood decoding section 9 is, for example, a Viterbi decoder. The maximum likelihood decoding section 9 decodes the reproduction signal which is PR-equalized by the PR equalization section 8 using a maximum likelihood decoding system of estimating a stream having the maximum likelihood based on the code rule intentionally added in accordance with the type of the partial response, and outputs binary data.

This binary data is treated as a demodulated binary signal and subjected to prescribed processing. As a result, the information recorded on the information recording medium 1 is reproduced.

The edge shift detection section 10 receives the waveform-shaped digital reproduction signal output from the PR equalization section 8 and the binary signal output from the maximum likelihood decoding section 9. The edge shift detection section 10 compares the transition data streams in Tables 1, 2 and 3 with the binary data. When the binary data matches the transition data streams in Tables 1, 2 and 3, the edge shift detection section 10 selects a state transition matrix 1 having the maximum likelihood and a state transition matrix 2 having the second maximum likelihood based on Tables 1, 2 and 3.

Based on the selection results, a metric, which is a distance between an ideal value of each state transition matrix (PR equalization ideal value; see Tables 1, 2 and 3) and the digital reproduction signal, is calculated. Also, a difference between the metrics calculated on the two state transition matrices is calculated. Finally, based on the binary signal, the edge shift detection section 10 assigns the metric difference to each of leading edge/trailing edge patterns of the recording mark, and finds an edge shift of a recording compensation parameter from the optimal value, for each pattern.

The recording compensation parameter determination section 16 classifies recording conditions by data pattern, including at least one recording mark and at least one space, of the data stream to be recorded.

The classification of the recording conditions by data pattern is performed as follows. The recording conditions are first classified using a combination of the length of a first recording mark included in the data stream and the length of a first space located adjacently previous or subsequent to the first recording mark. Then, the recording conditions are further classified using the length of a second recording mark which is not located adjacent to the first recording mark and is located adjacent to the first space.

Alternatively, the classification of the recording conditions by data pattern is performed as follows. The recording conditions are first classified using a combination of the length of a first recording mark included in the data stream and the length of a first space located adjacently previous or subsequent to the first recording mark. Then, the recording conditions are further classified using the length of a second space which is not located adjacent to the first space and is located adjacent to the first recording mark.

Namely, the recording compensation parameter determination section 16 determines a pattern table of the recording parameters, which are the recording conditions classified by data pattern. The pattern table does not need to be determined for each recording operation, and is uniquely determined in accordance with the type of the information recording medium 1 to which the data is to be recorded, conditions such as the recording speed, for example, 2×, and the PRML system of the reproduction signal processing.

The information recording control section 15 changes the setting of the recording parameter in accordance with the pattern table determined by the recording compensation parameter determination section 16.

It is noted here that the information recording control section 15 determines a position at which the recording parameter setting needs to be changed, based on the edge shift amount detected by the edge shift detection section 10. Therefore, it is desirable that the pattern classification obtained by the edge shift detection section 10 is the same as the pattern table classification obtained by the recording compensation parameter determination section 16.

The recording pattern generation section 11 generates an NRZI signal, which indicates the recording pattern, from the input recording data. The recording compensation section 12 generates a recording pulse stream in accordance with the NRZI signal based on the recording parameter changed by the information recording control section 15. The recording power setting section 14 sets recording powers including the peak power Pp and bottom power Pb. The laser driving section 13 controls the laser light emitting operation of the optical head 2 in accordance with the recording pulse stream and the recording powers which are set by the recording power setting section 14.

Hereinafter, an operation of the information recording and reproduction apparatus 100 will be described in more detail.

Referring to FIG. 1, when the information recording medium 1 is mounted, the optical head 2 moves to a recording area for adjusting the recording parameter to the optimal recording parameter. The recording area is, for example, a recording area for adjusting the recording powers and the recording pulse, which are provided in an innermost zone of the information recording medium.

The recording pattern generation section 11 outputs a pattern for recording adjustment to the recording compensation section 12 as recording data.

The information recording control section 15 applies initial recording conditions stored inside the recording and reproduction apparatus (for example, on a memory) to the recording conditions of the pattern table determined by the recording compensation pattern determination section 16, and thus sets the recording parameters of the recording pulse shape and the recording powers. In the case where the recording conditions are described in the information recording medium 1, information on the recording conditions may be obtained from the information recording medium 1 and applied to the initial recording conditions.

The recording compensation section 12 generates a recording pulse stream having the laser light emitting waveform in accordance with the pattern for the recording adjustment based on the recording pulse waveform, which is output from the information recording control section 15 as the recording parameter.

The recording power setting section 14 sets the recording powers including the peak power Pp and the bottom power Pb in accordance with the initial recording conditions provided by the information recording control section 15.

The laser driving section 13 controls the laser light emitting operation of the optical head 2 in accordance with the recording pulse stream generated by the recording compensation section 12 and the recording powers which are set by the recording power setting section 14. Then, the laser driving section 13 records the recording data on the information recording medium 1.

Next, the information recording and reproduction apparatus 100 reproduces recording data which has been recorded.

The optical head 2 generates an analog reproduction signal indicating information which is read from the information recording medium 1. The analog reproduction signal is amplified and AC-coupled by the preamplifier section 3 and then is input to the AGC section 4. By the AGC section 4, the gain is adjusted such that the output from the waveform equalizer 5 on a later stage has a constant amplitude. The analog reproduction signal output from the AGC section 4 is waveform-shaped by the waveform equalizer 5. The waveform-shaped analog reproduction signal is output to an A/D conversion section 6. The A/D conversion section 6 samples the analog reproduction signal in synchronization with a reproduction clock output from the PLL section 7. The PLL section 7 extracts the reproduction clock from a digital reproduction signal obtained by the sampling performed by the A/D conversion section 6.

The digital reproduction signal generated by the sampling performed by the A/D conversion section 6 is input to the PR equalization section 8. The PR equalization section 8 shapes the waveform of the digital reproduction signal. The maximum likelihood decoding section 9 performs maximum likelihood decoding on the waveform-shaped digital reproduction signal output from the PR equalization section 8 to generate a binary signal.

The edge shift detection section 10 receives the waveform-shaped digital reproduction signal output from the PR equalization section 8 and the binary signal output from the maximum likelihood decoding section 9. The edge shift detection section 10 also finds an edge shift, which is a shift of the recording compensation parameter from the optimal value. The edge shift is output to the information recording control section 15.

Based on the result of comparing the edge shift amount detected by the edge shift detection section 10 and a target amount of the edge shift stored inside the information recording and reproduction apparatus (for example, on a memory), the information recording control section 15 changes a recording parameter, the setting change of which is determined as being required, for example, a recording parameter which is different from the target value by more than a prescribed value (for example, an error of 20%).

The target value is desirably 0 because the edge shift is a shift of the recording parameter from the optimal value.

By the above-described operation, the information recording and reproduction apparatus 100 according to this embodiment performs a recording operation on the information recording medium 1, detects an edge shift amount by reproducing the recorded information, and updates and adjusts the recording condition such that the edge shift amount approaches the target value. In this manner, the information recording and reproduction apparatus 100 can optimize the recording condition.

The above-described recording operation is performed in accordance with the pattern table created in consideration of a high-order PRML system. Therefore, the recording is performed in consideration of edges of a plurality of marks and spaces, instead of an edge shift between one space and one recording mark considered in the conventional art. Hence, in high density recording which requires a high-order PRML system, the error rate of the recording information can be reduced, and a more stable recording and reproduction system can be provided.

So far, an embodiment of the present invention has been described with reference to the drawings.

In the above embodiment, the information recording and reproduction apparatus including the reproduction signal processing section 102 is used in order to describe the recording and reproduction operation. The present invention is also applicable to an information recording apparatus including only the recording control section 101 for performing only recording control. In this case, it is not necessary to adjust the recording condition. Such an information recording apparatus is applicable to a recording apparatus for performing only an information recording operation on, for example, a read only disc.

In the pattern tables in the above embodiment, the recording marks or spaces having a length of 5T or longer are put into one category. Alternatively, the recording marks or spaces having a length of 5T through the maximum length may be set differently from one another.

In the above embodiment, the edge position of the recording pulse is varied in accordance with the pattern. Alternatively, the entire recording pulse may be shifted in accordance with the pattern. In this case, the recording parameter used for recording adjustment is not necessary. Therefore, the memory capacity in the information recording and reproduction apparatus for storing the recording parameters can be reduced.

The recording conditions classified in the pattern tables may be described in the information recording medium. In this case, the recording compensation parameter determination section 16 does not need to determine the pattern table for each type of the information recording medium or for each recording speed. Therefore, the circuit scale can be reduced. In the case where the optimal recording condition for each information recording medium is described in accordance with the pattern table, the work or time of recording parameter adjustment can be reduced.

In the above embodiment, the target value of the edge shift is 0. Alternatively, the edge shift may be set for each type of information recording mediums of various manufacturers, for each recording speed, or for each specific pattern included in the pattern table. The target value is stored, for example, during the production of the information recording and reproduction apparatus. By keeping on storing target values corresponding to newly developed information recording mediums, compatibility to new information recording mediums is obtained. Therefore, it is desirable to store the target values on rewritable memories. A target value for a new information recording medium can be determined by reproducing the recording mark, formed with the optimal recording parameter, by the information recording and reproduction apparatus 100.

In the above embodiment, maximum likelihood decoding is performed using a state transition rule defined by a code having a shortest mark length of 2 and the equalization system PR(1,2,2,2,1). The present invention is not limited to this.

For example, the present invention is also applicable to a case where a code having a shortest mark length of 2 or 3 and the equalization system PR(C0, C1, C0) are used, to a case where a code having a shortest mark length of 2 or 3 and the equalization system PR(C0, C1, C1, C0) are used, or to a case where a code having a shortest mark length of 3 and the equalization system PR(C0, C1, C2, C1, C0) are used. C0, C1 and C2 are each an arbitrary positive numeral.

In the above embodiment, detailed classification is performed using only the marks and spaces having the shortest length, but the present invention is not limited to this. For example, the present invention is applicable to marks or spaces having the second shortest length, or marks or spaces having larger lengths, instead of marks having the shortest length.

The information recording medium in the above embodiment is not limited to an optical disc such as a CD, DVD or BD, and may be a magneto-optical medium such as an MO (Magneto-Optical Disc), or an information recording medium on which information is stored by changing the length or phase of the information in accordance with a polarity interval, by which the recording code (0 or 1) of a digital signal is continuous (such information is a recording mark or a space in the above embodiment).

A part of the recording and reproduction apparatus according to the present invention may be produced as a one-chip LSI (semiconductor integrated circuit) or a partial function thereof as a recording condition adjustment apparatus, which is for adjusting the recording pulse shape for recording information on an information recording medium. When a part of the recording and reproduction apparatus is produced as a one-chip LSI, the signal processing time for adjusting the recording parameter can be significantly reduced. Each part of the recording and reproduction apparatus may be independently produced as an LSI.

The present invention is also usable to other applications including recording and reproduction apparatuses for performing recording to or reproduction from various information recording mediums for storing data signals using laser light, electromagnetic force or the like, for example, DVD-RAM, BD-RE or other information recording mediums. Namely, the present invention is applicable to DVD drives, DVD recorders, BD recorders and the like, and is applicable for a recording operation in the above or other apparatuses.

What is claimed is:

1. A recording control apparatus for recording information on an information recording medium, comprising:
a recording compensation parameter determination section for classifying recording conditions by data pattern, including at least one recording mark and at least one space, of a data stream to be recorded;
wherein the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space.

2. The recording control apparatus of claim 1, wherein the classification using the length of the second recording mark is performed only when the length of the first space is equal to or less than a prescribed length.

3. The recording control apparatus of claim 1, wherein the classification by data pattern is further performed using the length of a second space which is not located adjacent to the first recording mark or the first space and is located adjacent to the second recording mark.

4. The recording control apparatus of claim 3, wherein the classification using the length of the second space is performed only when the length of the second recording mark is equal to or less than the prescribed length.

5. The recording control apparatus of claim 2, wherein the prescribed length is the shortest length in the data stream.

6. A recording control apparatus for recording information on an information recording medium, comprising:
a recording compensation parameter determination section for classifying recording conditions by data pattern, including at least one recording mark and at least one space, of a data stream to be recorded;
wherein the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

7. The recording control apparatus of claim 6, wherein the classification using the length of the second space is performed only when the length of the first recording mark is equal to or less than the prescribed length.

8. The recording control apparatus of claim 6, wherein the classification by data pattern is further performed using the length of a second recording mark which is not located adjacent to the first recording mark or the first space and is located adjacent to the second space.

9. The recording control apparatus of claim 8, wherein the classification using the length of the second recording mark is performed only when the length of the second space is equal to or less than the prescribed length.

10. The recording control apparatus of claim 7, wherein the prescribed length is the shortest length in the data stream.

11. A recording and reproduction method, comprising:
a reproduction signal processing step of generating a digital signal and decoding the digital signal into a binary signal, from a signal reproduced from an information recording medium using a PRML signal processing system; and
a recording control step of adjusting a recording parameter for recording information on the information recording medium based on the digital signal and the binary signal and recording the information on the information recording medium;
wherein:
the recording control step includes a recording compensation parameter determination step of classifying recording conditions by data pattern, including at least one recording mark and at least one space, of a data stream to be recorded; and
the classification of the recording conditions by data pattern is performed using a combination of the length of a first recording mark included in the data stream and the length of a first space located adjacently previous or subsequent to the first recording mark, and then further performed using the length of a second recording mark which is not located adjacent to the first recording mark and is located adjacent to the first space.

12. A recording and reproduction method, comprising:
a reproduction signal processing step of generating a digital signal and decoding the digital signal into a binary signal, from a signal reproduced from an information recording medium using a PRML signal processing system; and
a recording control step of adjusting a recording parameter for recording information on the information recording medium based on the digital signal and the binary signal and recording the information on the information recording medium;
wherein:
the recording control step includes a recording compensation parameter determination step of classifying recording conditions by data pattern, including at least one recording mark and at least one space, of a data stream to be recorded; and
the classification of the recording conditions by data pattern is performed using a combination of the length of a first recording mark included in the data stream and the length of a first space located adjacently previous or subsequent to the first recording mark, and then further performed using the length of a second space which is not located adjacent to the first space and is located adjacent to the first recording mark.

13. The recording and reproduction method of claim 11, wherein:
the reproduction signal processing step includes an edge shift detection step of calculating, from the binary signal, a differential metric which is a difference of a reproduction signal from a first state transition matrix having a maximum likelihood and a second state transition matrix having a second maximum likelihood, assigning the differential metric to each of leading edge/trailing edge patterns of the recording marks based on the binary signal, and finding an edge shift of the recording parameter from an optimal value for each pattern; and
the recording parameter is adjusted such that the edge shift approaches a prescribed target value.

14. The recording and reproduction method of claim 13, wherein the classification by data pattern obtained in the recording compensation parameter determination step and the classification by pattern obtained in the edge shift detection step are the same.
